(19) United States
(12) Patent Application Publication
(10) Pub. No.: US 2026/0180766 A1
(43) Pub. Date: Jun. 25, 2026

(54) METHOD, APPARATUS AND SYSTEM FOR SCHEDULING DOWNLINK UE COOPERATION TRANSMISSION

(71) Applicant: Huawei Technologies Co., Ltd., Shenzhen (CN)

(72) Inventors: Hua Xu, Ottawa (CA); Jianglei Ma, Ottawa (CA)

(21) Appl. No.: 19/538,506

(22) Filed: Feb. 12, 2026

Related U.S. Application Data
(63) Continuation of application No. PCT/CN2024/106645, filed on Jul. 22, 2024.
(60) Provisional application No. 63/520,012, filed on Aug. 16, 2023.

(51) Int. Cl. H04L 5/00

(52) U.S. Cl. CPC H04L 5/0053

(57) ABSTRACT

Systems and methods of scheduling for lower-layer transport block-based UE cooperation are provided. One or more PDCCH are used to schedule a downlink joint UE transmission, which may also be referred to as a UE cooperation (UC) transmission, from a transmitter and involving a first UE, also referred to as a target UE, and a second UE, also referred to as a cooperative UE. This may involve transmission of a single PDCCH to the transmitter, or transmitting a respective PDCCH to each of the transmitter and the second UE. The first UE receives a first TB based on scheduling information in the PDCCH. The second UE receives a second TB as part of the joint/UC transmission. Various design options for downlink control information carrying the scheduling information are provided.

### CROSS-REFERENCE TO RELATED APPLICATIONS

The present application is a continuation of International Application No. PCT/CN2024/106645, filed on Jul. 22, 2024, which claims priority to, U.S. provisional patent application Ser. No. 63/520,012, filed on Aug. 16, 2023, the entire contents of which are hereby incorporated by reference.

### TECHNICAL FIELD

The application relates to wireless communications generally, and more generally to a method, apparatus and system for scheduling user equipment (UE) cooperation transmission.

### BACKGROUND

In conventional wireless communication systems, each UE transmits/receives to/from the base station by itself; such systems can be viewed as being more cell-centric in nature. UE-to-UE communication has been studied and specified in the form of device to device communications to improve the communication between UEs directly.

UE cooperation (UC) concerns configuring a group of UEs to work together to improve transmission/reception to/from the base station as well as between UE(s). This can be viewed as more UE-centric in nature. This can be used to complement the conventional cell-centric system and improve overall system performance and capacity.

### SUMMARY

Methods, apparatuses, and systems of scheduling for lower-layer transport block-based UE cooperation are provided. One or more PDCCH are used to schedule a UE cooperation (UC) transmission involving a target UE and a cooperative UE. This may involve transmission of a single PDCCH to the target UE, or transmitting a respective PDCCH to each of the target UE and the cooperative UE. The target UE receives a first TB based on scheduling information in the PDCCH. The cooperative UE receives a second TB as part of the UC transmission. Various design options for downlink control information carrying the scheduling information are provided.

According to one aspect of the present disclosure, there is provided a method in a first user equipment (UE), the method comprising: receiving a first physical downlink control channel (PDCCH) scheduling a downlink UE cooperation (UC) transmission for the first UE in a target UE (TUE) role; receiving a first transport block (TB) based on the first PDCCH; receiving data from a second UE in a cooperative UE (CUE) role over an inter-UE connection.

In some implementations, receiving the first TB based on the first PDCCH comprises receiving the first TB from a network device.

In some implementations, receiving the first TB based on the first PDCCH comprises receiving the first TB from a third UE.

In some implementations, when the UC transmission is a TB duplicate UC transmission, the data is a duplicate of the first TB, or the data can be used to generate the first TB; when the UC transmission is a TB split UC transmission, the data is a second TB different than the first TB, or the data can be used to generate the second TB.

In some implementations, the first PDCCH includes an indication of whether the UC transmission is to be the TB duplicate UC transmission or the TB split UC transmission.

In some implementations, the method further comprises: receiving higher layer signaling to indicate whether the UC transmission is the TB duplicate UC transmission or the TB split UC transmission.

In some implementations, the first PDCCH contains scheduling information for only the first TB to indicate that the TB duplicate UC transmission is being scheduled; or the first PDCCH contains scheduling information for the first TB and the second TB to indicate that the TB split UC transmission is being scheduled.

In some implementations, the first PDCCH contains scheduling information for two TBs and in a case where the scheduling information for the two TBs is the same, the TB duplicate UC transmission is being scheduled, and in a case where the scheduling information for the two TBs is different, the TB split UC transmission is being scheduled.

In some implementations, the first PDCCH is scrambled with a first radio network temporary identifier (RNTI) to indicate the TB duplicate UC transmission and the first PDCCH is scrambled with a second RNTI to indicate the TB split UC transmission.

In some implementations, the method further comprises: receiving a second PDCCH scheduling a transmission of a normal downlink transmission to the first UE; wherein the first PDCCH is scrambled with a first radio network temporary identifier (RNTI) to indicate that the first PDCCH is scheduling the downlink UC transmission and the second PDCCH is scrambled with a second RNTI to indicate that the second PDCCH is scheduling the normal downlink transmission to the first UE.

In some implementations, for the TB duplicate UC transmission, the first PDCCH contains a new data indicator (NDI) indicating whether a new transmission is being scheduled or a retransmission is being scheduled.

In some implementations, for the TB split UC transmission, the first PDCCH contains a first new data indicator (NDI) indicating whether a new transmission or a retransmission is being scheduled for transmission to the first UE, and contains a second new data indicator (NDI) indicating whether a new transmission or a retransmission is being scheduled for transmission to the second UE in the CUE role.

According to another aspect of the present disclosure, there is provided an apparatus in a user equipment (UE) comprising at least one processor coupled with a memory storing instructions, wherein when the instructions executed by the at least one processor, cause the UE to execute a method comprising: receiving a first physical downlink control channel (PDCCH) scheduling a downlink UE cooperation (UC) transmission for the UE in a target UE (TUE) role; receiving a first transport block (TB) based on the PDCCH; receiving data from a second UE in a cooperative UE (CUE) role over an inter-UE connection.

In some implementations, receiving the first transport block (TB) based on the first PDCCH comprises receiving the first TB from a network device.

In some implementations, receiving the first transport block (TB) based on the first PDCCH comprises receiving the first TB from a third UE.

In some implementations, when the UC transmission is a TB duplicate UC transmission, the data is a duplicate of the first TB, or data can be used to generate the first TB; when the UC transmission is a TB split UC transmission, the data is a second TB different than the first TB, or the data can be used to generate the second TB.

In some implementations, the first PDCCH includes an indication of whether the UC transmission is to be the TB duplicate UC transmission or the TB split UC transmission.

In some implementations, the method further comprises: receiving higher layer signaling to indicate whether the UC transmission is the TB duplicate UC transmission or the TB split UC transmission.

In some implementations, the first PDCCH contains scheduling information for only the first TB to indicate the TB duplicate UC transmission is being scheduled; the first PDCCH contains scheduling information for the first TB and the second TB to indicate the TB split UC transmission is being scheduled.

In some implementations, the first PDCCH contains scheduling information for two TBs and in a case where the scheduling information for the two TBs is the same, the TB duplicate UC transmission is being scheduled, and in a case where the scheduling information for the two TBs is different, the TB split UC transmission is being scheduled.

In some implementations, the first PDCCH is scrambled with a first radio network temporary identifier (RNTI) to indicate the TB duplicate UC transmission and the first PDCCH is scrambled with a second RNTI to indicate the TB split UC transmission.

In some implementations, the method further comprises: receiving a second PDCCH scheduling a transmission of normal downlink transmission to the first UE; wherein the first PDCCH is scrambled with a first radio network temporary identifier (RNTI) to indicate that the first PDCCH is scheduling the downlink UC transmission and the second PDCCH is scrambled with a second RNTI to indicate that the second PDCCH is scheduling the normal downlink transmission to the first UE.

In some implementations, for the TB duplicate UC transmission, the first PDCCH contains a new data indicator (NDI) indicating whether a new transmission is being scheduled or a retransmission is being scheduled.

In some implementations, for the TB split UC transmission, the first PDCCH contains a first new data indicator (NDI) indicating whether a new transmission or a retransmission is being scheduled for transmission to the first UE, and contains a second new data indicator (NDI) indicating whether a new transmission or a retransmission is being scheduled for transmission to the second UE in the CUE role.

According to another aspect of the present disclosure, there is provided a method in a network device, the method comprising: transmitting a first physical downlink control channel (PDCCH) scheduling a downlink UE cooperation (UC) transmission for a first UE in a target UE (TUE) role; transmitting a first TB based on scheduling information in the PDCCH to the first UE; transmitting a second TB to a second UE in a cooperative UE (CUE) role.

In some implementations, when the UC transmission is a TB duplicate UC transmission, the second TB is a duplicate of the first TB; when the UC transmission is a TB split UC transmission, the second TB is different than the first TB.

In some implementations, the first PDCCH includes an indication of whether the UC transmission is to be the TB duplicate UC transmission or the TB split UC transmission.

In some implementations, the method further comprises: transmitting higher layer signaling to indicate whether the UC transmission is the TB duplicate UC transmission or the TB split UC transmission.

In some implementations, the first PDCCH contains scheduling information for only the first TB to indicate that the TB duplicate UC transmission is being scheduled; the first PDCCH contains scheduling information for the first TB and the second TB to indicate that the TB split UC transmission is being scheduled.

In some implementations, the first PDCCH contains scheduling information for two TBs and in a case where the scheduling information for the two TBs is the same, the TB duplicate UC transmission is being scheduled, and in a case where the scheduling information for the two TBs is different, the split TB UC transmission is being scheduled.

In some implementations, the first PDCCH is scrambled with a first radio network temporary identifier (RNTI) to indicate the TB duplicate UC transmission and the first PDCCH is scrambled with a second RNTI to indicate the TB split UC transmission.

In some implementations, the method further comprises: transmitting a second PDCCH scheduling a transmission of normal downlink UE transmission; wherein the first PDCCH is scrambled with a first radio network temporary identifier (RNTI) to indicate that the first PDCCH is scheduling the downlink UC transmission to the first UE and the second PDCCH is scrambled with a second RNTI to indicate that the second PDCCH is scheduling the normal downlink UE transmission to the first UE.

In some implementations, for the TB duplicate UC transmission, the first PDCCH contains a new data indicator (NDI) indicating whether a new transmission is being scheduled or a retransmission is being scheduled.

In some implementations, for the TB split UC transmission, the first PDCCH contains a first new data indicator (NDI) indicating whether a new transmission or a retransmission is being scheduled for transmission to the first UE, and contains a second new data indicator (NDI) indicating whether a new transmission or a retransmission is being scheduled for transmission to the second UE in the CUE role.

According to another aspect of the present disclosure, there is provided an apparatus in a network device comprising at least one processor coupled with a memory storing instructions, wherein when the instructions executed by the at least one processor, cause the network device to execute a method comprising: transmitting a first physical downlink control channel (PDCCH) scheduling a downlink UE cooperation (UC) transmission for a first UE in a target UE (TUE) role; transmitting a first transport block (TB) based on the first PDCCH to the first UE; transmitting a second TB to a second UE in a cooperative UE (CUE) role.

In some implementations, when the UC transmission is a transport block (TB) duplicate UC transmission, the second TB is a duplicate of the first TB; when the UC transmission is a transport block (TB) split UC transmission, the second TB is different than the first TB.

In some implementations, the first PDCCH includes an indication of whether the UC transmission is to be the TB duplicate UC transmission or the TB split UC transmission.

In some implementations, the method further comprises: transmitting higher layer signaling to indicate whether the UC transmission is the TB duplicate UC transmission or a TB split UC transmission.

In some implementations, the first PDCCH contains scheduling information for only the first TB to indicate that TB duplicate UC transmission is being scheduled; the first PDCCH contains scheduling information for the first TB and the second TB to indicate that TB split UC transmission is being scheduled.

In some implementations, the first PDCCH contains scheduling information for two TBs and in a case where the scheduling information for the two TBs is the same, the TB duplicate UC transmission is being scheduled, and in a case where the scheduling information for the two TBs is different, the split TB UC transmission is being scheduled.

In some implementations, the first PDCCH is scrambled with a first radio network temporary identifier (RNTI) to indicate the TB duplicate UC transmission and the first PDCCH is scrambled with a second RNTI to indicate the TB split UC transmission.

In some implementations, the method further comprises: transmitting a second PDCCH scheduling a transmission of normal downlink UE transmission; wherein the first PDCCH is scrambled with a first radio network temporary identifier (RNTI) to indicate that the first PDCCH is scheduling the downlink UC transmission to the first UE and the second PDCCH is scrambled with a second RNTI to indicate that the second PDCCH is scheduling the normal downlink UE transmission to the first UE.

In some implementations, for the TB duplicate UC transmission, the first PDCCH contains a new data indicator (NDI) indicating whether a new transmission is being scheduled or a retransmission is being scheduled.

In some implementations, for the TB split UC transmission, the first PDCCH contains a first new data indicator (NDI) indicating whether a new transmission or a retransmission is being scheduled for transmission to the first UE, and contains a second new data indicator (NDI) indicating whether a new transmission or a retransmission is being scheduled for transmission to the second UE in the CUE role.

According to another aspect of the present disclosure, a method in a first UE involves receiving a first PDCCH scheduling a downlink joint UE transmission from a transmitter for the first UE, receiving a first TB from the transmitter based on the first PDCCH, and receiving data from a second UE over an inter-UE connection.

In some implementations, the transmitter is a network device, and receiving the first TB based on the first PDCCH involves receiving the first TB from the network device.

In some implementations, the transmitter is a third UE, and receiving the first TB based on the first PDCCH involves receiving the first TB from the third UE.

In some implementations, when the joint UE transmission is a TB duplicate joint UE transmission, the data is a duplicate of the first TB, or the data can be used to generate the first TB.

In some implementations, when the joint UE transmission is a TB split joint UE transmission, the data is a second TB different than the first TB, or the data can be used to generate the second TB.

In some implementations, the first PDCCH includes an indication of whether the joint UE transmission is to be the TB duplicate joint UE transmission or the TB split joint UE transmission.

In some implementations, a method further involves receiving higher layer signaling to indicate whether the joint UE transmission is the TB duplicate joint UE transmission or the TB split joint UE transmission.

In some implementations, the first PDCCH contains scheduling information for only the first TB to indicate that the TB duplicate joint UE transmission is being scheduled; or the first PDCCH contains scheduling information for the first TB and the second TB to indicate that the TB split joint UE transmission is being scheduled.

In some implementations, the first PDCCH contains scheduling information for two TBs and in a case where the scheduling information for the two TBs is the same, the TB duplicate joint UE transmission is being scheduled, and in a case where the scheduling information for the two TBs is different, the TB split joint UE transmission is being scheduled.

In some implementations, the first PDCCH is scrambled with a first RNTI to indicate the TB duplicate joint UE transmission and the first PDCCH is scrambled with a second RNTI to indicate the TB split joint UE transmission.

In some implementations, a method further involves receiving a second PDCCH scheduling a transmission of normal downlink transmission to the first UE, in which case the first PDCCH may be scrambled with a first RNTI to indicate that the first PDCCH is scheduling the downlink joint UE transmission and the second PDCCH may be scrambled with a second RNTI to indicate that the second PDCCH is scheduling the normal downlink transmission to the first UE.

In some implementations, for the TB duplicate joint UE transmission, the first PDCCH contains an NDI indicating whether a new transmission is being scheduled or a retransmission is being scheduled.

In some implementations, for the TB split joint UE transmission, the first PDCCH contains a first NDI indicating whether a new transmission or a retransmission is being scheduled for transmission to the first UE, and contains a second NDI indicating whether a new transmission or a retransmission is being scheduled for transmission to the second UE.

According to yet another aspect of the present disclosure, an apparatus includes at least one processor coupled with a memory storing instructions, and the instructions, when executed by the at least one processor, cause a UE to execute a method. The method involves receiving a first PDCCH scheduling a downlink joint UE transmission from a transmitter for the UE, receiving a first TB from the transmitter based on the first PDCCH, and receiving data from a second UE over an inter-UE connection.

In some implementations, the transmitter is a network device, and receiving the first TB based on the first PDCCH involves receiving the first TB from the network device.

In some implementations, the transmitter is a third UE, and receiving the first TB based on the first PDCCH involves receiving the first TB from the third UE.

In some implementations, when the joint UE transmission is a TB duplicate joint UE transmission, the data is a duplicate of the first TB, or the data can be used to generate the first TB.

In some implementations, when the joint UE transmission is a TB split joint UE transmission, the data is a second TB different than the first TB, or the data can be used to generate the second TB.

In some implementations, the first PDCCH includes an indication of whether the joint UE transmission is to be the TB duplicate joint UE transmission or the TB split joint UE transmission.

In some implementations, a method further involves receiving higher layer signaling to indicate whether the joint UE transmission is the TB duplicate joint UE transmission or the TB split joint UE transmission.

In some implementations, the first PDCCH contains scheduling information for only the first TB to indicate that the TB duplicate joint UE transmission is being scheduled; or the first PDCCH contains scheduling information for the first TB and the second TB to indicate that the TB split joint UE transmission is being scheduled.

In some implementations, the first PDCCH contains scheduling information for two TBs and in a case where the scheduling information for the two TBs is the same, the TB duplicate joint UE transmission is being scheduled, and in a case where the scheduling information for the two TBs is different, the TB split joint UE transmission is being scheduled.

In some implementations, the first PDCCH is scrambled with a first RNTI to indicate the TB duplicate joint UE transmission and the first PDCCH is scrambled with a second RNTI to indicate the TB split joint UE transmission.

In some implementations, a method further involves receiving a second PDCCH scheduling a transmission of normal downlink transmission to the UE, in which case the first PDCCH may be scrambled with a first RNTI to indicate that the first PDCCH is scheduling the joint UE transmission and the second PDCCH may be scrambled with a second RNTI to indicate that the second PDCCH is scheduling the normal downlink transmission to the UE.

In some implementations, for the TB duplicate joint UE transmission, the first PDCCH contains an NDI indicating whether a new transmission is being scheduled or a retransmission is being scheduled.

In some implementations, for the TB split joint UE transmission, the first PDCCH contains a first NDI indicating whether a new transmission or a retransmission is being scheduled for transmission to the UE, and contains a second NDI indicating whether a new transmission or a retransmission is being scheduled for transmission to the second UE.

A further aspect of the present disclosure relates to a method that involves transmitting a first PDCCH scheduling a downlink joint UE transmission from a transmitter for a first UE, transmitting a first TB of data from the transmitter to the first UE based on scheduling information in the first PDCCH, and transmitting a second TB of data from the transmitter to a second UE.

In some implementations, when the joint UE transmission is a TB duplicate joint UE transmission, the second TB is a duplicate of the first TB.

In some implementations, when the joint UE transmission is a TB split joint UE transmission, the second TB is different than the first TB.

In some implementations, the first PDCCH includes an indication of whether the joint UE transmission is to be the TB duplicate joint UE transmission or the TB split joint UE transmission.

In some implementations, a method further involves transmitting higher layer signaling to indicate whether the joint UE transmission is the TB duplicate joint UE transmission or the TB split joint UE transmission.

In some implementations, the first PDCCH contains scheduling information for only the first TB to indicate that the TB duplicate joint UE transmission is being scheduled, or the first PDCCH contains scheduling information for the first TB and a second TB to indicate that the TB split joint UE transmission is being scheduled.

In some implementations, the first PDCCH contains scheduling information for two TBs and in a case where the scheduling information for the two TBs is the same, the duplicate TB joint UE transmission is being scheduled, and in a case where the scheduling information for the two TBs is different, the split TB joint UE transmission is being scheduled.

In some implementations, the first PDCCH is scrambled with a first RNTI to indicate the TB duplicate joint UE transmission and the first PDCCH is scrambled with a second RNTI to indicate the TB split joint UE transmission.

In some implementations, a method further involves transmitting a second PDCCH scheduling a transmission of normal downlink UE transmission, in which case the first PDCCH may be scrambled with a first RNTI to indicate that the first PDCCH is scheduling the joint UE transmission and the second PDCCH may be scrambled with a second RNTI to indicate that the second PDCCH is scheduling the normal UE transmission.

In some implementations, for the TB duplicate joint UE transmission, the first PDCCH contains an NDI indicating whether a new transmission is being scheduled or a retransmission is being scheduled.

In some implementations, for the TB split joint UE transmission, the first PDCCH contains a first NDI indicating whether a new transmission or a retransmission is being scheduled for transmission to the first UE, and contains a second NDI indicating whether a new transmission or a retransmission is being scheduled for transmission to the second UE.

An apparatus according to a further aspect of the present disclosure includes at least one processor coupled with a memory storing instructions, and the instructions, when executed by the at least one processor, cause a transmitter to execute a method. Such a method may involve transmitting a first PDCCH scheduling a joint UE transmission from the transmitter for a first UE, transmitting a first TB of data from the transmitter to the first UE based on the first PDCCH, and transmitting a second TB of data to a second UE.

In some implementations, when the joint UE transmission is a TB duplicate joint UE transmission, the second TB is a duplicate of the first TB.

In some implementations, when the joint UE transmission is a TB split joint UE transmission, the second TB is different than the first TB.

In some implementations, the first PDCCH includes an indication of whether the joint UE transmission is to be the TB duplicate joint UE transmission or the TB split joint UE transmission.

In some implementations, a method further involves transmitting higher layer signaling to indicate whether the joint UE transmission is the TB duplicate joint UE transmission or a TB split joint UE transmission.

In some implementations, the first PDCCH contains scheduling information for only the first TB to indicate that TB duplicate joint UE transmission is being scheduled or the first PDCCH contains scheduling information for the first TB and a second TB to indicate that TB split joint UE transmission is being scheduled.

In some implementations, the first PDCCH contains scheduling information for two TBs and in a case where the scheduling information for the two TBs is the same, the duplicate TB joint UE transmission is being scheduled, and in a case where the scheduling information for the two TBs is different, the split TB joint UE transmission is being scheduled.

In some implementations, the first PDCCH is scrambled with a first RNTI to indicate the TB duplicate joint UE transmission and the first PDCCH is scrambled with a second RNTI to indicate the TB split joint UE transmission.

In some implementations, a method further involves transmitting a second PDCCH scheduling a transmission of normal downlink UE transmission, in which case the first PDCCH may be scrambled with a first RNTI to indicate that the first PDCCH is scheduling the joint UE transmission and the second PDCCH may be scrambled with a second RNTI to indicate that the second PDCCH is scheduling the normal downlink UE transmission.

In some implementations, for the TB duplicate joint UE transmission, the first PDCCH contains an NDI indicating whether a new transmission is being scheduled or a retransmission is being scheduled.

In some implementations, for the TB split joint UE transmission, the first PDCCH contains a first NDI indicating whether a new transmission or a retransmission is being scheduled for transmission to the first UE, and contains a second NDI indicating whether a new transmission or a retransmission is being scheduled for transmission to the second UE.

According to an aspect of the present disclosure, there is provided a communication system, comprising an apparatus in a TUE shown above, an apparatus in a network side shown above. In addition, the system includes at least one CUE.

A system may also be described as including a first UE or an apparatus that causes such a UE to perform a method, at least one second UE or an apparatus that causes such a UE to perform a method, and a transmitter or an apparatus that causes a transmitter to perform a method.

According to an aspect of the present disclosure, there is provided a computer program comprising instructions. The instructions, when executed by a processor, may cause the processor to implement the method of any one of any one of above aspects or implementations.

According to an aspect of the present disclosure, there is provided a non-transitory computer-readable medium storing instructions, and the instructions, when executed by a processor, may cause the processor to implement the method of any one of any one of above aspects or implementations.

### BRIEF DESCRIPTION OF THE DRAWINGS

Embodiments of the disclosure will now be described with reference to the attached drawings in which:

FIG. 1 is a block diagram of a communication system.

FIG. 2 is a block diagram of a communication system.

FIG. 3 is a block diagram of a communication system showing a basic component structure of an electronic device (ED) and a base station.

FIG. 4 is a block diagram of modules that may be used to implement or perform one or more of the steps of embodiments of the application.

FIGS. 5A, 5B and 5C are block diagrams that illustrate joint scheduling for User Equipment Cooperation (UC).

FIG. 6 is a block diagram that illustrates bit level scrambling and physical downlink control channel (PDCCH) cyclic redundancy check (CRC) scrambling.

FIG. 7 is a block diagram that illustrates two types of data transmission.

FIG. 8A is a block diagram that illustrates a first type of transport block (TB)-based User Equipment Cooperation (UC) referred to as split TB UC data transmission.

FIG. 8B is a block diagram that illustrates a second type of TB-based UC referred to as TB duplicate UC data transmission.

FIG. 9A is a block diagram showing the use of higher layer signaling to indicate TB-split UC data transmission.

FIG. 9B is a block diagram showing the use of higher layer signaling to indicate TB-duplicate UC data transmission.

FIG. 10 is a block diagram of an example of a common PDCCH carrying a common downlink control information (DCI) for scheduling two transport blocks (2 TB).

FIG. 11 is a block diagram of an example where separate PDCCHs for target user equipment (TUE) and cooperative user equipment (CUE).

FIG. 12 is a flowchart of an example of a method for execution by a UE acting as a TUE, featuring TB duplication.

FIG. 13 is a flowchart of an example of a method for execution by a UE acting as a TUE, featuring TB split.

FIG. 14 is a flowchart of an example of a method for execution by a UE acting as a CUE.

FIG. 15 is a block diagram that illustrates Inter-UE data transmission that employs TB buffers and circular block buffers in the PHY layers of the TUE and CUE.

FIG. 16 is a block diagram that illustrates hybrid automatic repeat request (HARQ) control by the TUE MAC layer.

FIG. 17 is a block diagram that illustrates HARQ control by the CUE MAC layer.

FIG. 18 is a block diagram that shows an example of data/signaling flow for UC with TB duplicate method.

FIG. 19 is a block diagram that shows an example of data/signaling flow for UC with TB split method.

FIG. 20 is a block diagram that illustrates code block group (CBG) based re-transmission for UC.

FIG. 21 is a block diagram that illustrates a HARQ configuration to support both UC and non-UC data traffic.

### DETAILED DESCRIPTION

UE cooperation is a new subject in 3GPP. In Rel-18, it is studied and specified under the subject of multi-path support and UE aggregation. The main goal could be to improve the downlink (DL) throughput and reliability by increasing the number of transmission paths between the base station and target UE (or destination UE).

3GPP refers to 3^{rd} generation partnership project.

In the systems under study in 3GPP Rel-18, as part of the UE cooperation approach, data split/duplication is performed at the packet data control protocol (PDCP) layer. This approach may not fully exploit the dynamic channel variations.

As compared with PDCP layer data split/duplicate, UE cooperation (UC) at a lower protocol layer could be used to further improve the performance such as throughput and latency. For example, transport block (TB)-based UC may be better suited to exploit dynamic channel variation and maximize performance. Systems and methods of scheduling TB-based UC are provided. In future generations of wireless communication (e.g., 5.5G or future network), a large number of devices (mobile phones/devices, Internet of things (IoT) devices, cooperative UE (CUE), industry sensors/monitor etc.) could be deployed.

5.5G refers to 5.5^{th} generation, and more generally a number followed by “G” refers to that numbered generation of wireless communication system.

UE cooperation could be employed to meet the needs of low power, long battery life, limited capability, capability/coverage enhancement etc. To be more specific, the data originated/destined from/to one device (source/target device) could be transmitted to/received by a group of cooperative devices.

The connection between UEs for UC purposes may not necessarily be specified by 3GPP and can be achieved by non-3GPP connection including a wired or wireless connection.

Joint scheduling can be used to facilitate UC transmission/reception. For uplink transmission, the joint scheduling could include scheduling information for the transmission of multiple data packets (or the same duplicated packets) originated at the source device (SUE) from multiple cooperative devices (CUE) and the source device itself to the network in the uplink or to another device over a sidelink. For downlink transmission, the joint scheduling could include scheduling information for multiple data packets (or the same duplicated packets) to be transmitted from a source device or network (e.g., the gNB) to a target device (TUE) directly as well as to multiple cooperative devices where the data packets are destined to the target device.

In either case, the scheduling information for each packet may include one or more of parameters such as: resource allocation (RA), modulation and coding scheme (MCS), HARQ ID, redundancy version (RV) etc. Joint scheduling could work together with individual scheduling (per UC transmission or per transmission without UC) together.

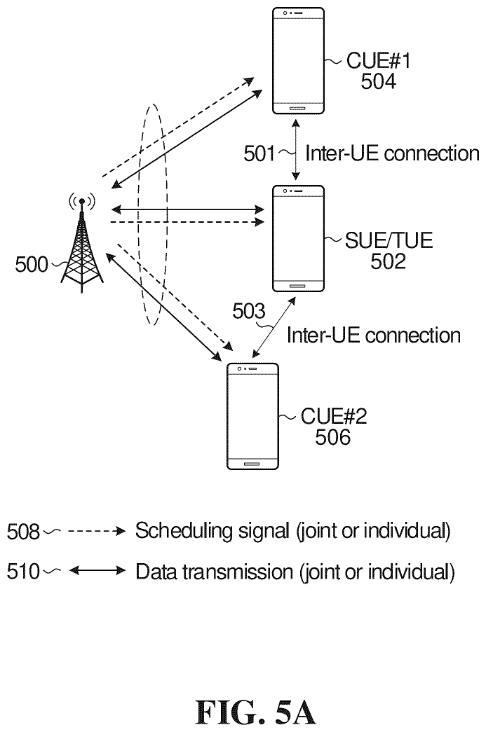

The scenarios described herein will generally focus on downlink UC transmission and reception, but the provided methodologies can be applicable to uplink, sidelink and downlink transmission. Thus, for example, the data transmission as shown in FIG. 5A could be either uplink or downlink. Uplink data transmissions may be carried by a physical uplink shared channel (PUSCH) channel and downlink data transmissions may be carried by physical downlink shared channel (PDSCH) channel in 3GPP New Radio (NR) standard (aka 5G standard). Most mechanisms provided herein can be applicable to both uplink and downlink unless specified explicitly.

For example, for downlink UC transmission, the joint scheduling could include scheduling information for scheduling multiple data packets (or the same duplicated packets) transmissions from the source next generation (or 5G) base station (gNB) (or source network device) to respective devices including the destined device (or destined/target UE, or target (or destined) UE (TUE)) and cooperative devices. The cooperative devices may relay the data packets to the TUE.

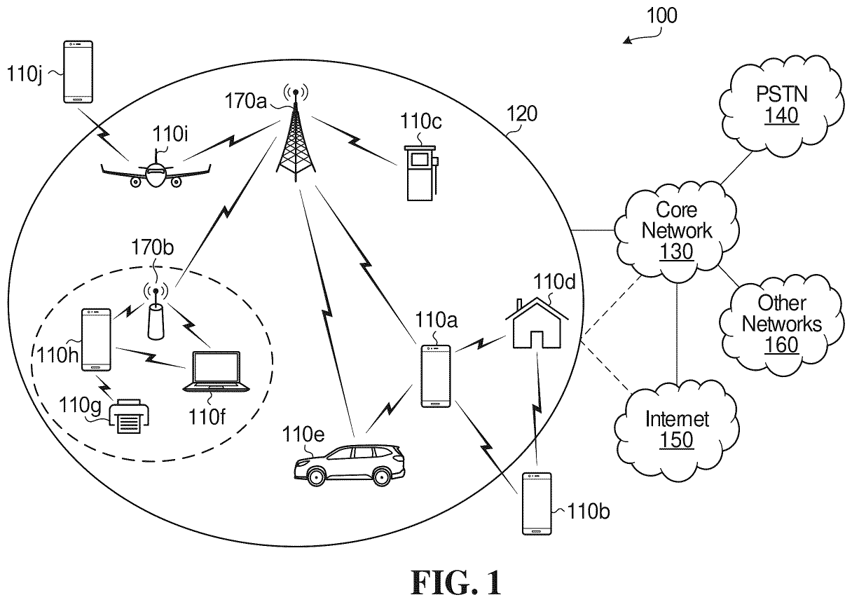

Referring to FIG. 1, as an illustrative example without limitation, a simplified schematic illustration of a communication system is provided. The communication system 100 comprises a radio access network 120. The radio access network 120 may be a next generation radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network130 may be a part of the communication system and may be dependent or independent of the radio access technology used in the communication system 100. Also, the communication system 100 comprises a public switched telephone network (PSTN) 140, the internet 150, and other networks 160.

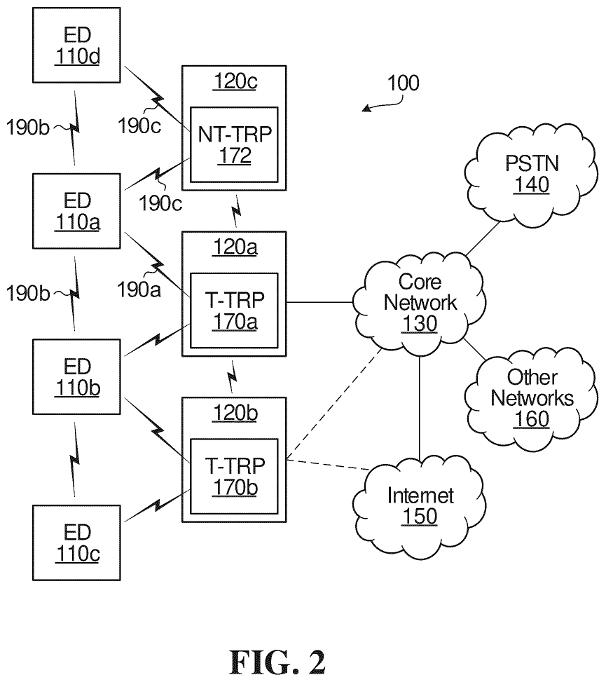

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery, and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-transport/receive point (TRPs)) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130 and may or may not employ the same radio access technology as RAN 120a, RAN 120b or both. The core network 130 may also serve as a gateway access between (i) the RANs 120a and 120b or EDs noa 110b, and 110c or both, and (ii) other networks (such as the PSTN 140, the internet 150, and the other networks 160). In addition, some, or all, of the EDs 110a iiob, and noc may include functionality for communicating with different wireless networks over different wireless links using different wireless technologies and/or protocols. Instead of wireless communication (or in addition thereto), the EDs 110a 110b, and noc may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and noc may be multimode devices capable of operation according to multiple radio access technologies and may incorporate multiple transceivers necessary to support such operation.

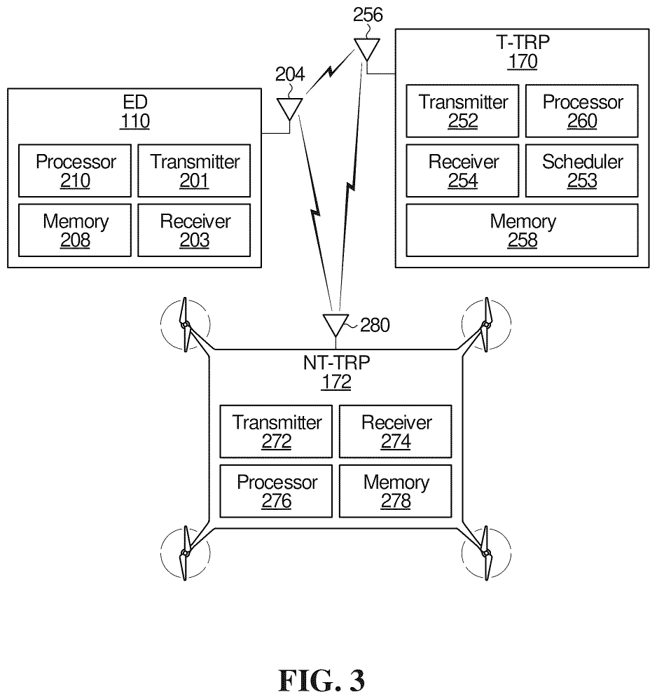

FIG. 3 illustrates another example of an ED no and a base station 170a, 170b and/or 170c. The ED no is used to connect persons, objects, machines, etc. The ED no may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modern, or chip) in the foregoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one or more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 may also include at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read-only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. communication module, modem, or chip) in the foregoing devices.

In some implementations, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

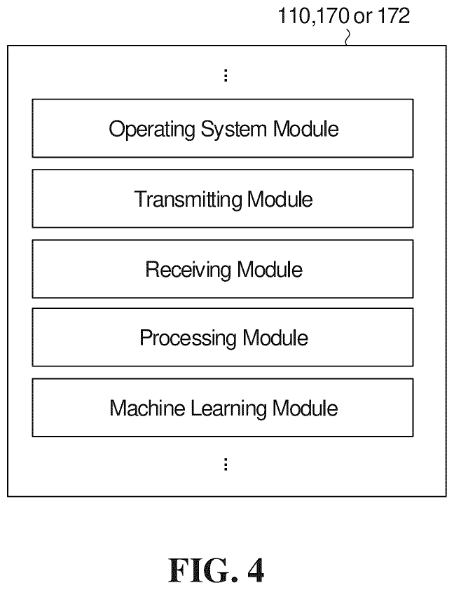

One or more steps of the methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor, for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Methods, apparatuses and systems of scheduling for lower layer downlink UC data transmission, for example transport block (TB)-based downlink UC transmission are provided. While the description focuses on TB-based downlink UC transmission, the approach can be applied for other lower layer UC transmissions such as UC implemented/realized in MAC and PHY layers. The provided methods, apparatuses and systems may address/mitigate one or more of:
how to distinguish PDCCH for normal data transmission and UC data transmission;
how to distinguish PDCCH for DL TB-split or TB-duplicate UC transmission;
DCI design for DL UC transmission including new data indicator (NDI) design;
Corresponding UE (TUE and CUE) behaviors for TB-based UC transmission including information sharing on inter-UE link;
HARQ operation control;
CBG based HARQ handling;
HARQ process configuration for UC traffic and non-UC traffic.

### Distinction Between Scheduling a UE'S Own Traffic and Uc Traffic

In this implementation, systems and methods for distinguishing between scheduling a UE's own downlink traffic (or non-UC traffic) and downlink UC traffic as well as distinguishing between scheduling different types of UC traffic are provided.

Downlink UC data transmission refers to a target UE (TUE) and (one or more) CUE(s) cooperatively receiving data from the network, e.g., from a base station. Note the described approaches are also applicable for cooperative data transmission from a UE to a TUE and one or more CUEs. The distinction between normal UE traffic (i.e., UE's own traffic) and UC traffic will be described with reference to FIG. 5A. FIG. 5A shows a gNB 500, and three UEs 502,504,506. Any of the UEs may receive its own data from the gNB 500 without UC cooperation. In addition, one or more UEs may act as CUEs to assist in the reception of data for another UE acting as a TUE. In the example of FIG. 5A, in a specific example of UC data transmission, UEs 504,506 are acting as CUEs to assist in the reception of data for UE 502 which is acting as a TUE. There is an inter-UE connection 501 between UE 502 and UE 504, and another inter-UE connection 503 between UE 502 and UE 506. As mentioned above, these links may or may not be standardized by 3GPP. Also shown is the transmission of scheduling signal(s) 508 from the gNB 500 to the UEs 502, 504, 506 for the purpose of scheduling normal downlink UE data transmission and downlink UC data transmissions 510.

Embodiments may be described herein with reference primarily to UC data transmission, a SUE or target UE (TUE) and (one or more) CUE(s) cooperatively transmitting data from the SUE (and/or to a TUE). UC is a form of joint transmission by multiple UEs (for example an SUE and one or more CUEs), and “joint UE transmission” or “joint transmission” may also be used to refer to cooperatively transmitting data as disclosed herein. SUE, TUE, and CUE refer to UEs, and UE behaviors that may be different depending on whether a UE is acting as or implementing an SUE, TUE, or CUE, or in other words is in an SUE, TUE, or CUE role. Features disclosed herein in the context of an SUE, TUE, or CUE or a UE in an SUE, TUE, or CUE role, for example, apply more generally to UEs that may be configured or operative to work together for joint transmission of data.

FIG. 5B shows another example showing that the network side could include a number of TRPs (transmit and receive points) 550,552 instead of a network entity such as gNB.

FIG. 5C shows another example where another UE 560 transmits/receives data to/from a group of UEs (TUE/SUE and a number of CUEs) in a UC manner. In this case, the air-interface between such another UE(s) and a group of UE(s) could be a sidelink interface. For example, the control signal for scheduling could be in the format of sidelink control information (SCI) and carried by a physical sidelink control channel (PSCCH)/physical sidelink shared channel (PSSCH). The data could be carried by PSSCH.

The transmissions to/from different TUE/SUE could be on the same or different frequency band as those transmission to/from a CUE. For example, in FIG. 5A, the transmission (downlink/sidelink) to/from the TUE/SUE could be on the same or different frequency band as those transmissions to/from CUE #i or CUE #2. The transmission (downlink/sidelink) to/from the CUE #i could be on the same or different frequency band as those transmission to/from CUE #2.

For any of the implementations of FIGS. 5A, 5B, and 5C, the scheduling signals include a distinction between the two types of data transmission such that a UE receiving the scheduling signal knows whether it is a normal downlink UE data transmission as opposed to a downlink UC data transmission.

For example, where PDCCH scheduling is used for scheduling these two types of data transmission, the PDCCH scheduling includes a distinction between the two types of data transmission. Please note that in the present disclosure, the PDCCH scheduling a UC transmission or normal UE transmission could also be described as: the downlink control information (e.g., DCI) transmitted in the PDCCH scheduling a UC transmission or normal UE transmission.

In some embodiments, radio network temporary identifiers (RNTIs) are used for this purpose. Different RNTIs can be used to scramble contents of the PDCCH depending on whether the transmission being scheduled is a normal downlink UE data transmission or a downlink UC data transmission. In a specific example, a PDCCH scheduling normal downlink UE data transmission to a UE uses a normal UE RNTI for scrambling, e.g., the receiving UE's conventional C-RNTI, and a PDCCH scheduling UC data transmission uses a new UE RNTI for scrambling. More generally, different RNTIs known to both the transmitter and receiver can be used for the two purposes.

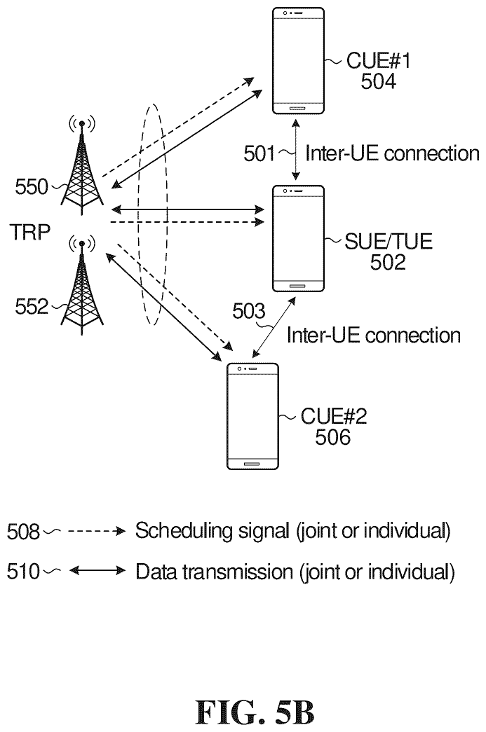

One or both of bit-level scrambling and PDCCH cyclic redundancy check (CRC) scrambling can be applied using this new UE RNTI or can be called UC RNTI. An example is shown in FIG. 6. In FIG. 6, at the transmitter, shown is a set of DCI bits 602 and generated CRC bits 604. This is subject to scrambling with an RNTI 606 which is one of two RNTIs that distinguish between normal UE data transmission and UC transmission. In the illustrated example, this is referred to as the “new RNTI” or UC RNTI, which is used to indicate UC transmission. In another way of applying this, shown is an encoder 608 which produces an encoded bit stream including CRC and this is subject to bit level scrambling in bit scrambler 610 with the new RNTI at 612.

In some embodiments, a common PDCCH is used for scheduling UC data transmission to both TUE and CUE. In this case, a new common RNTI can be configured and used for scrambling the common PDCCH. Both the TUE and CUE receive and process the common PDCCH. In some embodiments, a respective separate PDCCH is used for scheduling UC data transmission to the TUE and each CUE. In this case, the TUE and CUE each receive and process the respective separate PDCCH. In this case, separate new RNTI(s) could be configured for the TUE and each CUE respectively and used for scrambling PDCCHs for the TUE and each CUE for respective reception by the TUE and the CUE.

### Distinction Between Scheduling Different Types of Downlink TB-Based UC Traffic

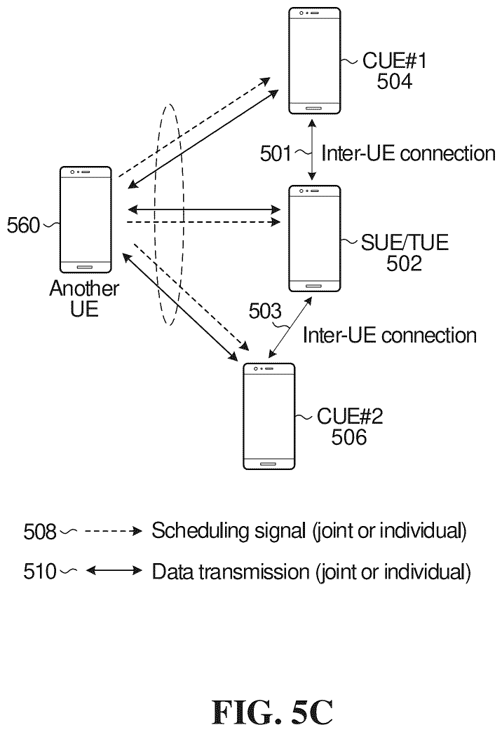

An example of TB-based downlink UC data transmission will be further described with reference to FIG. 7 which shows a gNB 700, a first UE 702 configured to function as an TUE, and a second UE 704 configured to function as a CUE to assist the TUE in data reception from the gNB 700. UE 702 has MAC and PHY layers 710,712. UE 704 has corresponding layers 714,716 and gNB 700 has corresponding layers 718, 720. A TB for reception as normal UE data of the first UE 702 is indicated at 722, which shows TB 722 received by PHY 712 for processing by MAC 710. A TB for reception as normal UE data of the second UE 704 is indicated at 724 which shows TB 724 received by PHY 716 for processing by MAC 714. Finally, TB(s) for UC transmission include a TB 726 received by PHY 712 for processing by MAC 710, and a TB 728 received by PHY 716, for being passed to the TUE 702 for processing by MAC 710 of the TUE.

In the context of the joint transmission example shown, the joint transmission is for data originated from a transmitter, source, or source device, which is the gNB 700 in FIG. 7 but may be or include TRPs as shown by way of example in FIG. 5B or another UE as shown by way of example in FIG. 5C. Such data may also be referred to, for example, as data that originates from the transmitter, source, or source device. A joint transmission may be described, for example, as a joint transmission for such data, a joint transmission of such data, a joint transmission from a transmitter, source, or source device, or a joint transmission for a UE or more generally for a receiver, a target, a target device, or a destination device. These are examples only, and other terminology may be used to describe a joint transmission.

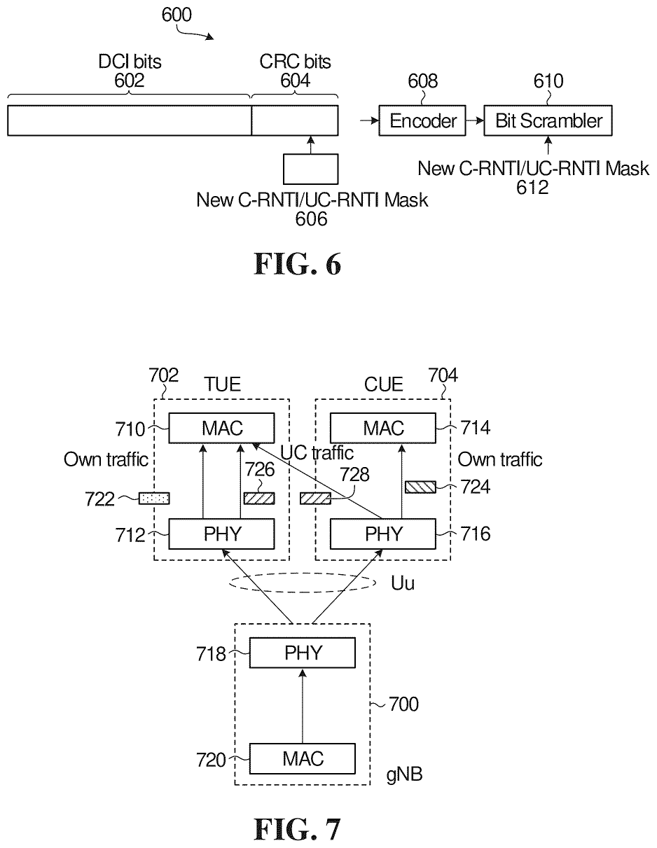

UC data transmission may be in the form of split UC data transmission or duplicate UC transmission. With split UC data transmission, the TUE and CUE are receiving different data of the TUE, whereas with duplicate UC transmission, the TUE and CUE are receiving the same data of the TUE. In a specific example, data duplication/split occurs at the TB level; examples of this are shown in FIGS. 8A and 8B, which show two types of TB-based UC. FIG. 8A shows split TB downlink UC data transmission. In this case, for the UC transmission, a first TB 800 is transmitted to and received by the TUE 702, and a second different TB 802 is transmitted to and received by the CUE 704 which is then conveyed to the TUE. In this case, two different TBs are transmitted by the gNB, one to the TUE and one to the CUE. Each TB is managed by a separate hybrid automatic repeat request (HARQ) process.

FIG. 8B shows TB duplicate downlink UC data transmission. In this case, for the UC transmission, a first TB 810 is transmitted to and received by the TUE UE 702, and a TB 812 is transmitted to and received by the CUE which is then conveyed to the TUE. In this case, the same TB is duplicated and transmitted or simply broadcast by the gNB to both the TUE and the CUE. Both TBs (or the broadcast TB) transmitted to the TUE and the CUE are managed by a single (the same) HARQ process, as the TB(s) contain the same data.

In the detailed examples described herein, it is assumed that UC transmission involves multiple UEs receiving data cooperatively from a network device such as a gNB; however, UC transmission can alternatively involve multiple UE cooperatively receiving data from another UE (source UE).

In the detailed examples described herein, TB-based UC transmission (TB-duplicate or TB-split) is used. Other types of data duplication and data splitting may alternatively be employed (for example, data duplication or data split may not occur at TB level but in other unit/format/packet) and similar mechanisms to those described herein for scheduling UE, UE behaviors, signal/data flow etc. may be used.

There are different alternatives for distinguishing between these split and duplicate TB-based UC transmission. In some embodiments, different RNTIs for PDCCH scrambling are used to distinguish between split TB transmission and TB duplicate transmission. For example, a PDCCH scheduling split TB transmission can use a first new UE RNTI-1 for scrambling. Both or either one of bit-level scrambling and PDCCH CRC scrambling based on UE RNTI-1 can be applied. A PDCCH scheduling TB duplicate transmission can use a second new UE RNTI-2 for scrambling. Both or either one of bit-level scrambling and PDCCH CRC scrambling based on UE RNTI-2 can be applied.

For the TUE, both RNTI-1 and RNTI-2 could be configured to distinguish between TB-split and TB duplicate type of UC transmission. When the TUE receives a PDCCH scrambled with RNTI-1, the TUE knows that the transmission is a TB-split transmission, and so the TUE receives a different TB from the CUE. When the TUE receives a PDCCH scrambled with RNTI-2, the TUE knows the transmission is a TB duplicate transmission, and so it receives the same TB from the CUE. When the UE functioning as a TUE receives normal traffic, it can use its normal RNTI for that; if the same UE can also function as a CUE to help with another TUE to receive a UC transmission, the UE may be assigned with a third RNTI for scrambling corresponding PDCCH.

For a UE functioning as a CUE, only one extra RNTI is configured for UC transmission as it may not need to distinguish between TB-split or TB-duplicate UC transmission; rather, the CUE simply receives the TB from the gNB and conveys this to the TUE, and this may be a duplicate or a different TB compared to the TB transmitted to the TUE itself.

In some embodiments, a single new RNTI is used in place of both new RNTI-1 and RNTI-2 for the TUE, where distinguishing between TB-split and TB duplicate UC transmission is achieved by other means, for example configured by high-layer signaling.

The same or different new RNTI could be configured for both TUE and CUE for UC data traffic. They could be referred as UC-RNTI.

If a common DCI is used for scheduling DL UC data transmission for both TUE and CUE, two new common RNTI(s) like group RNTI can be configured and used for scrambling the common PDCCH(s), one for scheduling TB-split downlink UC transmission and one for scheduling TB-split downlink UC transmission. If separate DCI are used for scheduling UC transmission for TUE and CUE respectively, separate sets of new RNTI(s) could be configured for TUE and CUE respectively and used for scrambling PDCCHs for TUE and CUE to schedule TB-split or TB-duplicate UC transmission respectively. Such new RNTIs can also be used to determine the locations of PDCCH(s) scheduling UC traffic transmitted in the corresponding control resource set CORESET(s).

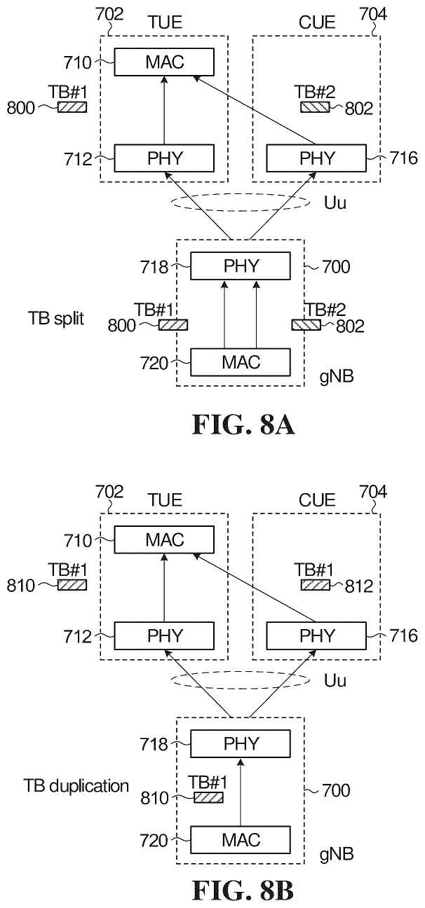

In some embodiments, higher layer signaling is used to configure TB-duplicate and TB-split downlink UC data transmission. For example, a radio resource control (RRC) signal, or a medium access control (MAC) control element (CE) signal could be used. In some embodiments, the high-layer configuration is sent to the TUE only, as the CUE may not need to distinguish TB-split or TB-duplicate UC transmission. An example is shown in FIG. 9A where higher layer signaling 900 is used to indicate TB-split downlink UC data transmission. An example is shown in FIG. 9B where higher layer signaling 902 is used to indicate TB-duplicate downlink UC data transmission.

Common and separate PDCCH are discussed above. The actual scheduling information is contained in DCI(s) transmitted using such common or separate PDCCH. Several alternatives for the contents of DCI used for scheduling UC transmission are provided.

In a first alternative, if TB-duplicate UC transmission is configured, the DCI intended for the TUE will contain scheduling information for a single TB, otherwise if TB-split UC transmission is configured, the DCI for the TUE will contain scheduling information for two TB(s). The scheduling information for a first of the two TBs is used for a reception of a first TB by the TUE. The scheduling information for a second of the two TBs is used by the CUE for reception of the second TB, which is then conveyed to the TUE.

In a second alternative, the DCI to the TUE only contains scheduling information for one TB, and if TB-split is configured, a second TB with the same size as the first TB will be expected to be received by the CUE and conveyed to the TUE.

In a third alternative, the DCI to the TUE always contains scheduling information for two TBs, and if TB-duplicate is configured, the second TB has the same size as the first TB and the TUE expects to receive a duplicate TB from the CUE. Otherwise, if TB-split is configured, the second TB could have different size compared to that of the first TB. The TUE then expects to receive two different TBs, one being received by the TUE from the network/SUE and the other being received from the CUE.

In a fourth alternative, the DCI to the TUE contains scheduling information only for one TB, and if TB-split is configured, a second TB with the same size as the first TB will be expected to be received by the CUE and conveyed to the TUE.

In some implementations, one of the two types of TB-based UC transmission (split and duplicate) is implicitly indicated in the DCI to the TUE.

In a first example of this approach, if DCI(s) sent to the TUE contain scheduling for a single TB (or a single codeword (CW), where typically a TB is encoded into one CW) this is used to imply/indicate TB duplicate UC transmission and the same TB will be duplicated and transmitted to both TUE and CUE. In this case, the scheduling part for a second TB may be filled with padding bits or zeros for easy detection. On the other hand, if DCI(s) sent to the TUE contain scheduling information for two TBs, this is used to imply/indicate TB split UC transmission and in this case different TBs are expected to be unicast to the TUE and CUE respectively. In this case, the DCI size is fixed regardless of whether TB-split or TB-duplicate UC transmission is scheduled.

In some implementations, the TB size for each TB is derived from an assigned time-frequency resource and corresponding MCS indicated for each TB.

The UE can implicitly determine whether it is TB-duplicate or TB-split UC data traffic by detecting whether DCI contains scheduling information for one TB or two TB(s).

In a second example of this approach, if DCI(s) sent to the TUE contain scheduling for two TB and such scheduling information are the same (e.g., MCS, HARQ ID, RV for each TB are the same), this is used to imply/indicate TB duplicate UC transmission and the same TB will be duplicated and transmitted to both TUE and CUE respectively or a single TB be broadcast to both TUE and CUE. On the other hand, if DCI(s) sent to the TUE contain scheduling information for two TBs and such scheduling information are different (e.g., MCS, HARQ ID, RV for each TB are different), this is used to imply/indicate TB split UC transmission in which case different TBs will be prepared and transmitted to the TUE and CUE respectively. The UE can implicitly determine whether it is TB-duplicate or TB-split UC transmission by detecting scheduling information for both TB(s) and ascertaining whether the scheduling information is the same or different.

In either case, the DCI size could be based on scheduling two TB transmission, thus the DCI size is fixed regardless of whether TB-split or TB-duplicate UC transmission is scheduled. Again, the TB size could be derived from an assigned time-frequency (T-F) resource and MCS indicated for each TB.

### Detailed DCI Design Options for TB-Based UC Transmission

In a first alternative, a same DCI (common DCI) containing the scheduling information for two TB(s) can be used (for both TUE and CUE). The common PDCCH carrying such DCI (or PSCCH/PSSCH carrying SCI on a sidelink from another transmitting UE)) could be transmitted from a shared/same resource (e.g., a shared control resource set (CORESET) with shared/same search space) or separate resource (e.g., separate CORESET(s) and separate search space) configured for TUE and CUE respectively. In this case, a same new RNTI (different from the conventional C-RNTI) could be configured and used to scramble the CRC of the common DCI.

In some implementations, a common DCI carried by the common PDCCH contains one common set of time-frequency resources for both TUE and CUE transmission. This implies overlapping transmissions to the TUE and the CUE on the same time-frequency resource.

The common DCI may contain one or more HARQ process numbers (HARQ ID) and corresponding redundancy version (RV) (one HARQ ID and/or one RV for each TB). For TB duplication, one HARQ process is used and thus one HARQ ID and one or more RV is indicated for the same TB transmitted to different UE (TUE or CUE). For TB split, more than one HARQ process are used, one for each TB. Therefore, more than one HARQ ID and their corresponding RV are indicated in the common DCI, one for each TB. Alternatively, a first HARQ ID can be indicated while the other HARQ ID can be derived from the first HARQ ID, for example the second HARQ ID=first HARQ ID+offset. In a specific example of this approach, second HARQ ID=first HARQ ID+1, third HARQ ID=first HARQ ID+2 and so on.

The common DCI may contain one or more NDI, one for each TB, indicating whether it is a new transmission or a retransmission.

For data duplication, one NDI is used. If NDI is toggled, new data is transmitted to both TUE and CUE. If NDI is not toggled, then retransmission of the same old TB is performed to both the TUE and CUE.

For data split, two NDI can be indicated (more generally one NDI for the TUE and one NDI for each CUE). In this case, the NDI for the TUE indicates whether the TB being transmitted to the TUE is new or a retransmission, and the NDI for each CUE indicates whether the TB being transmitted to the CUE is new or a retransmission. In this manner, new transmissions and re-transmissions to the TUE and CUE can be scheduled independently.

In some implementations, the DCI includes demodulation reference symbol (DMRS) indications for two TBs (or two CW), one for each UE.

For this implementation, the TUE would use the scheduling information for one or both TB(s) to expect reception of data by itself or via the CUE. The CUE would only use the scheduling information for one TB (e.g., the second TB) to receive the data.

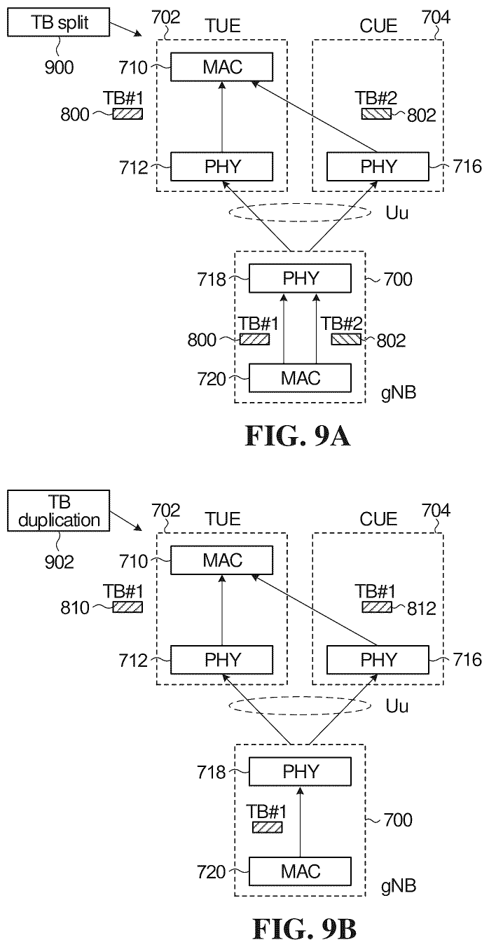

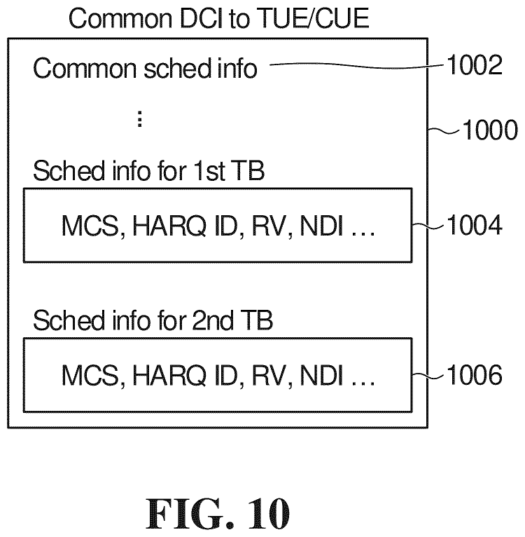

FIG. 10 shows an example of a common PDCCH carrying a common DCI 1000 for scheduling 2 TBs (max e.g. maximum 2CW) transmission. A DCI format similar to DCI format 1-1 in NR may be used. The common DCI 1000 includes common scheduling information 1002 applicable to scheduling both TBs to avoid duplication which may include resource allocation etc., and scheduling information 1004 specific for the first TB (including, for example, one or more of MCS, HARQ ID, RV. NDI), and scheduling information 1006 specific for the second TB.

If TB duplication is scheduled, in addition to the common scheduling information 1002, the DCI includes the scheduling information 1004 specific to the first TB while the scheduling information (or part/field) 1006 part specific to the 2nd TB is filled with padding bits or zeros. If TB split is scheduled, scheduling information 1004,1006 for two TBs is included.

In this case, data duplicate or data split can be implicitly signaled to the TUE by the inclusion of scheduling information for only one TB (e.g., the first TB) or by inclusion of scheduling information for both the first and second TBs.

If the TUE detects that the DCI contains scheduling information for only one TB, the TUE uses this to conclude TB-duplicate type of UC traffic is scheduled; otherwise, if TUE detects DCI contains scheduling info of two TB, the TUE uses this to conclude TB-split type of UC traffic is scheduled.

The TB size for each TB may be derived from the assigned T-F resource and corresponding MCS indicated for each TB. The TUE and CUE will receive their respective UC transmission on the same T-F resource as scheduled by the common DCI in the common scheduling information field. For TB split type of UC transmission, in addition, the TUE will receive its part of a UC transmission (e.g., first TB) based on the scheduling information specific for the first TB and the CUE will receive its part of the UC transmission (e.g., second TB) based on the scheduling information specific for the second TB. For TB-split type of UC transmission, two TB(s) transmitted to the TUE and CUE respectively could have different TB size.

Upon receiving the second TB by the CUE, the CUE needs to pass the decoded TB or some intermediate data obtained during decoding to its destination TUE. The scheduling of transmission of the second TB from CUE to TUE is not specified if a non-3GPP inter-UE link is used. However, if 3GPP specified interface is used for inter-UE link, some resource can be configured on the inter-UE link to transmit the second TB received by CUE to the TUE. For example, configured grant (CG) can be used to configure some resource on inter-UE link if PC5 link is used to carry the second TB from the CUE to the TUE, thus such scheduling information for inter-UE link does not need to be carried by the common DCI.

In some embodiments, separate PDCCH(s) for TUE and CUE are used, and they could be transmitted from separate CORESET(s) configured for TUE or CUE respectively. An example is shown in FIG. 1i. FIG. 1i shows a first DCI (transmitted on a first PDCCH) 1100 for the TUE. This DCI contains other scheduling information 1102 common to both the first and second TB, and scheduling information 1104 specific for the first TB and scheduling information 1106 specific for the second TB. Also shown is a second DCI (transmitted on a second PDCCH) 1110 for the CUE which contains scheduling information 1114 specific for the TB transmitted to the CUE for subsequent conveyance to the TUE and some other scheduling information 1112.

The PDCCH for the TUE may contain scheduling information for two TB(s) and is used to schedule UC transmission to the TUE from the gNB. It is also used to prepare reception of the TB(s) of UC data traffic received by the CUE following the same principle as mentioned for the common PDCCH.

For TB-split case, an alternative can be used to indicate the TB size for the second TB. To be more specific, a scheduling field specific for second TB can be reused to carry the TB size of the second TB directly or other relevant information that can be used to derive the TB size of the second TB. For example, the specific fields to carry MCS, HARQ ID and RV for the second TB as shown in FIG. 10 can be used to carry second TB size or other relevant information that can be used to derive that.

Similar to the common PDCCH case, the scheduling of the second TB from CUE to TUE is not specified if a non-3GPP inter-UE link is employed. However, if a 3GPP specified interface is used for inter-UE link, some resource can be configured on an inter-UE link to transmit second TB from CUE to the TUE. For example, configured grant (CG) can be used to configure some resource on the inter-UE link if a PC5 link is used to carry the second TB from CUE to TUE, thus such scheduling information for inter-UE link does not need to be carried by the PDCCH(s) to TUE or CUE.

In some embodiments, the PDCCH for the CUE contains scheduling information for one TB and is used to schedule UC data traffic to the CUE.

In some embodiments, the HARQ ID is consistent in respective PDCCH (or DCI) for the TUE and the CUE. For example, if data is duplicated, the same HARQ ID may be used in the PDCCH for the TUE and in the PDCCH for the CUE. Different RVs may be used for the transmissions to the TUE and the CUE. If data is split, the same HARQ ID may be used in both the PDCCH for the TUE and the PDCCH for the CUE for the TB that is transmitted from the gNB to the CUE (and conveyed to TUE). Thus, the HARQ ID for the TB transmitted to the CUE (and conveyed to TUE) is consistent across the TUE, CUE and gNB.

The HARQ ID and RV received/decoded by CUE could be conveyed to TUE and if there exist some discrepancy between HARQ ID and/or RV received by TUE and those received by CUE, the TUE could ignore them during joint HARQ combining.

In some embodiments, the NDI in respective PDCCH (or DCI) for TUE and CUE shall be consistent. For example, if data is duplicated, the NDI can be toggled together in both PDCCH for TUE and CUE respectively such that both TUE and CUE will expect to receive new TB (data).

In some embodiments, the TB size derived from respective PDCCH (or DCI) for TUE and CUE shall be consistent with the TB decoded by CUE. If the TB size obtained by TUE from its PDCCH is different from the size of the TB decoded by CUE, the TB could be dropped. Alternatively, the TB decoded by CUE is considered valid (or succeed) if passing CRC test while the TB size obtained by TUE from the PDCCH is ignored.

If NDI in a DCI for TUE is toggled meaning new data is expected, while the TB passed from CUE shows it is an old TB, the TUE may skip HARQ combining on received data from CUE.

If NDI in a DCI for TUE is not toggled meaning re-transmission for old data, while the TB passed from CUE shows it is a new TB, the TUE may skip HARQ combining on received data from CUE.

### The UE Behavior for TB-Based Uc Transmission

In this embodiment, different UE methods or behaviors for implementing TB-based UC transmission/reception are provided. Functionality will be described for TUE and CUE respectively. Of course, a given UE can be configured to function as TUE for some transmissions, and/or CUE for other transmissions.

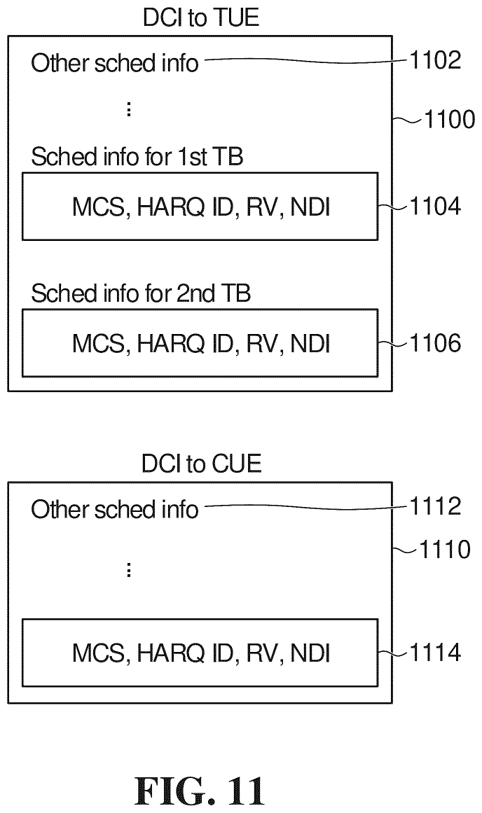

FIG. 12 is a flowchart of an example of a method for execution by a UE acting as a TUE, featuring TB duplication. The method begins in block 1200 with reception and decoding of a PDCCH scheduling downlink UC data traffic with TB duplication. If it is new data (NDI is toggled), yes path block 1202, this means that it is a new TB. At block 1206, the TUE will try to decode the received data. Otherwise, it is the re-transmitted data (no path, block 1202) and the TUE will try to combine the received data with that in its HARQ soft buffer (stored from previous transmissions) and decode it at block 1204. If the decoding succeeds (yes path block 1208), the TUE will send an ACK to the gNB for the TB at block 1218. If decoding fails (no path block 1208), the TUE will check if decoding of the same TB at a CUE succeeds, and if yes (yes path block 1210), the TUE will receive the decoded TB from the CUE at block 1212 and send an ACK to gNB at 1218. If both the TUE and the CUE fail in decoding the TB separately (no path block 1210), the TUE could obtain the received data from the CUE and combine that with the data in TUE HARQ soft buffer and decode the combined data at 1214, if this decoding succeeds (yes path block 1216), the TUE will send an ACK to the gNB at 1218. Otherwise, the TUE will send a NACK to the gNB at block 1220. It should be noted that the order of using separate decoding and joint decoding operations is up to implementation.

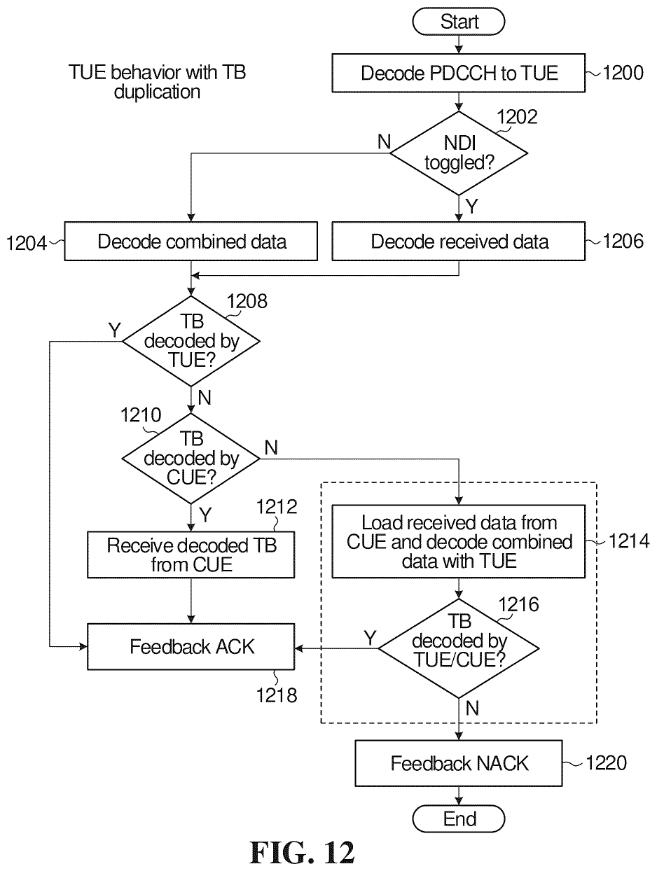

FIG. 13 is a flowchart of an example of a method for execution by a UE acting as a TUE, featuring TB split. The method begins in block 1300 with reception and decoding of a PDCCH scheduling downlink UC data traffic with TB split (similar to scheduling 2 CW for 2 TBs). If NDI for the first TB is toggled (yes path block 1302), the TUE will try to decode the received data at 1308 and if successful, yes path block 1312, the TUE will send an ACK for the first TB to the gNB at 1318, otherwise, no path block 1312, it will send NACK for the first TB to the gNB at 1320. If NDI for the first TB is not toggled (no path block 1302), the TUE will try to decode combined data (current data and previously received data) at block 1306 and if successful, yes path block 1312, the TUE will send an ACK for the first TB to the gNB at 1318, otherwise, no path block 1312, it will send a NACK for the first TB to the gNB at 1320.

The TUE also checks an indication from the CUE on decoding the second TB. If this indicates a success in decoding (yes path block 1304), the TUE will receive the decoded second TB from the CUE at block 1310 and send an ACK for the second TB to the gNB at 1316, otherwise, it will send a NACK for the second TB to the gNB at 1314. If the second TB is not successfully decoded by the CUE, no path block 1304, then the TUE sends a NACK to the gNB at 1314.

As indicated previously, the inter-UE connection may or may not be specified by 3GPP. For example, this connection could be a wired or wireless connection based on the specification out of 3GPP such WiFi, Bluetooth, Ethernet etc.

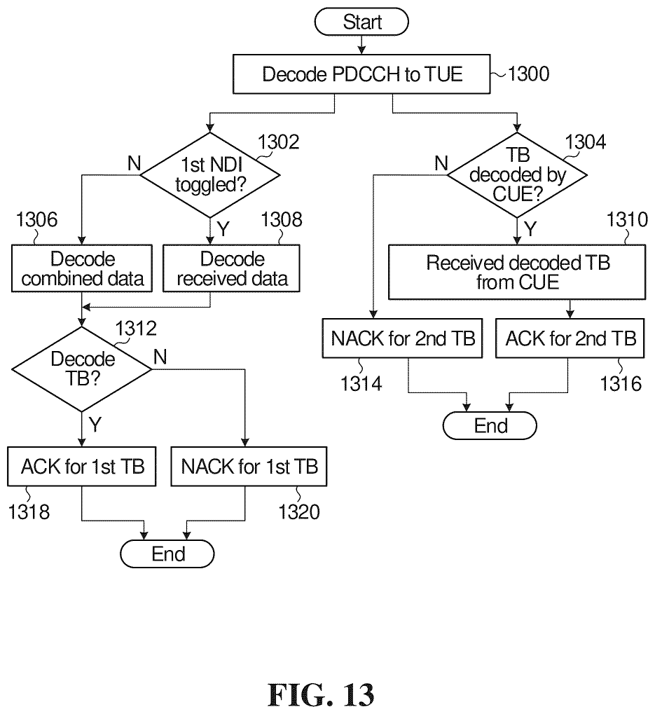

FIG. 14 is a flowchart of an example of a method for execution by a UE acting as a CUE. The method begins in block 1400 with reception and decoding of a PDCCH scheduling downlink UC data traffic for the CUE. If NDI is toggled (yes path block 1402), the CUE will try to decode the received data at 1406 and if successful, yes path block 1408, the CUE will send the decoded TB and ACK to the TUE at block 1410 via inter-UE link. Otherwise, if decoding is not successful, the CUE will send a NACK to the TUE at 1412 via inter-UE link. If NDI for the TB is not toggled (no path block 1402), the CUE will try to decode combined data (current data and previously received data) at block 1404 and if successful, yes path block 1408, the CUE will send the decoded TB and ACK to the TUE at block 1410. Otherwise, if decoding is not successful, the CUE will send a NACK to the TUE at 1412. Optionally, if decoding fails (no path block 1408), the CUE also sends received data (could be in the form of soft symbols from decoding of the TB) to the TUE at 1412 along with corresponding HARQ ID, RV and NDI information.

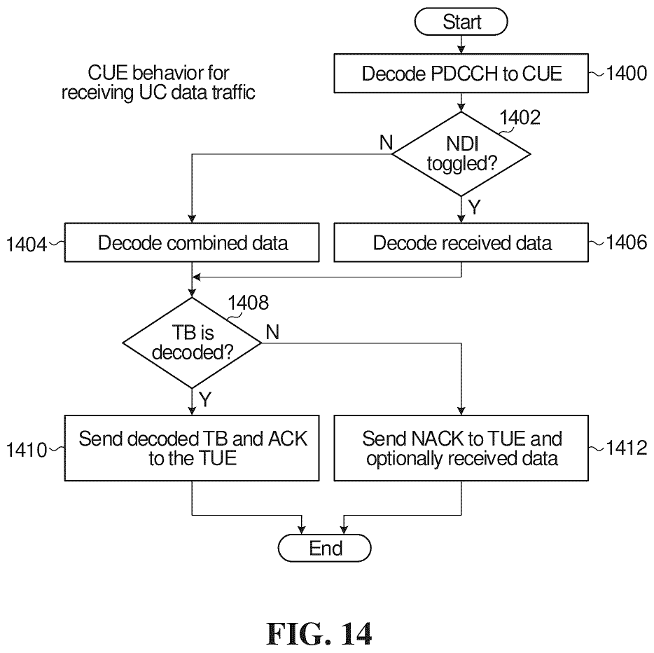

FIG. 15, which includes like numbering from previously described FIG. 7, also shows TB buffers 1500 and 1502 used by TUE and CUE to store TB data and exchange such data between them via inter-UE links. The HARQ buffers 1504 and 1506 in PHY layers 712,716 may be conventional HARQ soft buffers in the TUE and CUE respectively to store data after channel decoding in the PHY layer.

For UC transmission in the downlink, the destination UE is the TUE and the HARQ entity managing UC transmission may be configured in the MAC layer of the TUE. Various alternatives for the HARQ control for UC transmission at the CUE will now be described.

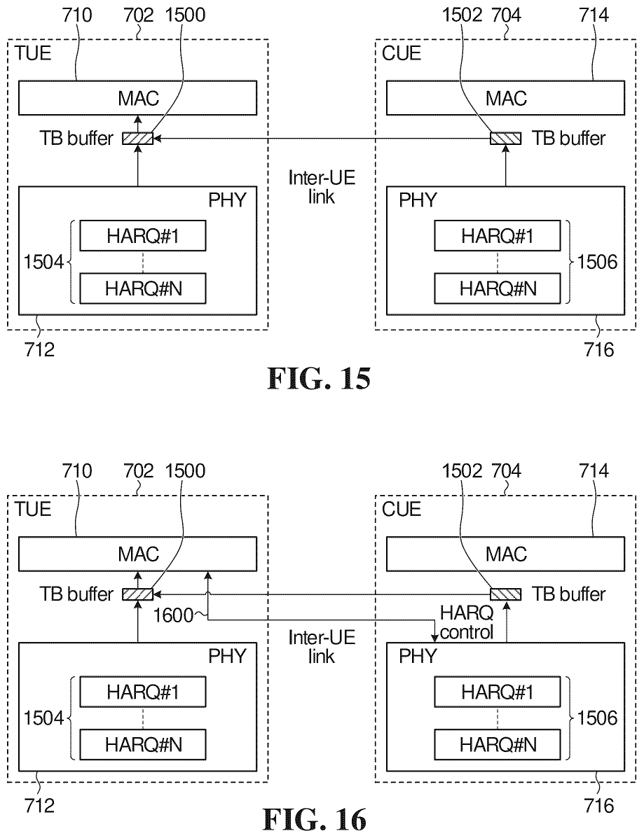

In a first alternative, shown in FIG. 16 which shows like numbering from FIGS. 7 and 15, the HARQ control for the CUE is done in a HARQ entity configured in the TUE MAC layer 710. In this case, the HARQ information decoded from the DCI such as HARQ ID, RV and NDI for the CUE is passed to TUE MAC layer 710 and the HARQ transmission decision is sent at 1600 from the TUE MAC layer 710 to the PHY layer 716 of the CUE for HARQ processing. This is similar to legacy behavior and may incur more latency as the HARQ control needs to be exchanged between TUE and CUE.

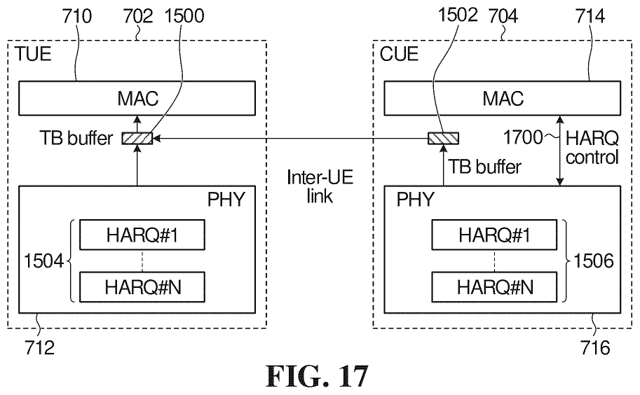

In a second alternative, shown in FIG. 17, which again shows like numbering from FIGS. 7 and 15, the HARQ control for the CUE is done with assistance from the MAC layer 714 in the CUE. In this case, some HARQ entity functionality for UC transmission is configured and implemented in the MAC layer 714 of the CUE. The HARQ information decoded from the DCI at the CUE could be passed to the MAC 714 of the CUE at 1700 and the MAC layer 714 of the CUE could make the decision for HARQ operation. This alternative would lead to lower latency as HARQ control is done in the CUE.

For example, if HARQ information decoded from the DCI indicates a re-transmission of an earlier transmission, the MAC layer of the CUE could instruct its PHY to combine the received data with that stored in the HARQ soft buffer from the earlier transmission and try to decode them together. Otherwise, if the HARQ information such as NDI indicates it is a new TB, the MAC layer of the CUE could instruct its PHY layer to decode the received data as a new TB. If the decoding (after the first transmission or re-transmissions) is successful, the CUE sends an ACK indication to the TUE along with the decoded TB; otherwise, the CUE sends a NACK indication to the TUE, and optionally, the CUE sends HARQ soft information to the TUE.

In general, the inter-UE interface could carry one or more of following information between TUE and CUE(s) to facilitate the data transmission for UC:
the decoded TB from CUE(s);
intermediate soft information (not decoded information bits) of the received data from CUE(s) for TUE to combine;
HARQ information such as HARQ ID, RV, NDI etc.;
ACK/NACK information of a decoded TB from CUE(s).

The inter-UE interface itself may or may not be 3GPP specified. However, the information carried through such interface may be specified/configured along with necessary information such as window/timing/period of the information sharing, the procedure of the information sharing etc.

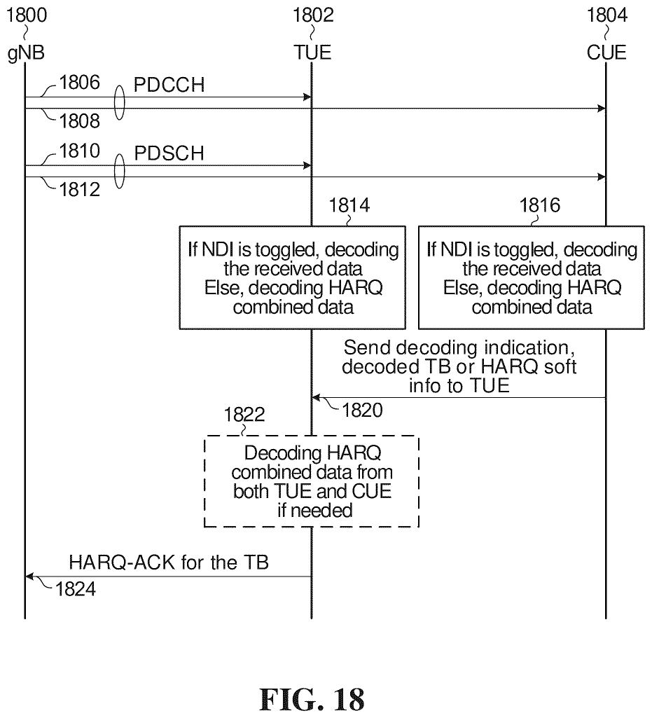

FIG. 18 shows a signal/data flow example for a TB duplicate procedure between gNB 1800, TUE 1802, and CUE 1804. The example begins with the transmission of PDCCH at 1806,1808. This is followed by PDSCH transmissions at 1810,1812. For the PDSCH transmission 1810 to the TUE 1802, at 1814, if NDI is toggled, then the TUE 1802 decodes the received data, and otherwise, the TUE 1802 decodes HARQ combined data. For the PDSCH transmission 1812 to the CUE 1804, at 1816, if NDI is toggled, then the CUE 1804 decodes the received data, and otherwise, the CUE 1804 decodes HARQ combined data. At 1820, If the CUE 1804 is successful in decoding received data, the CUE 1804 sends a successful decoding indication, and the decoded TB to the TUE 1802, and otherwise, sends HARQ soft information to the TUE 1802. At 1822, the TUE 1802 decodes HARQ combined data from both the TUE 1802 and CUE 1804 if needed. If successful, the TUE 1802 sends a HARQ-ACK feedback (ACK or NACK) for the TB to the gNB 1800 at 1824.

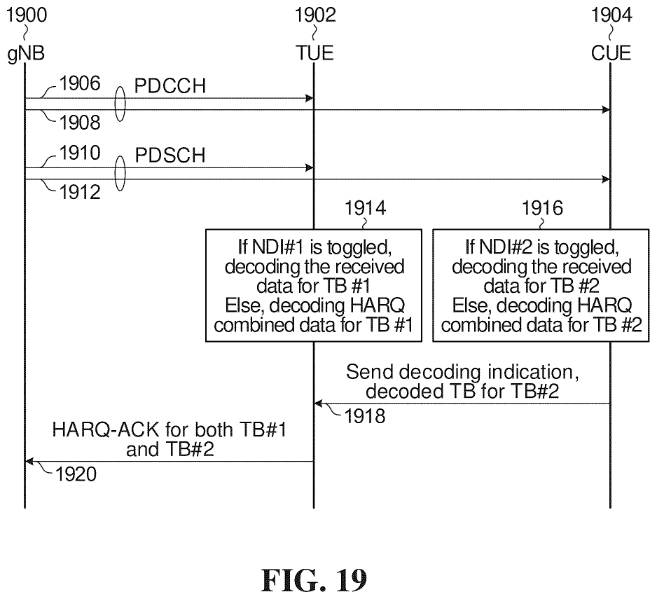

FIG. 19 shows a signal/data flow example for a TB split procedure between gNB 1900, TUE 1902, and CUE 1904. The example begins with the transmission of PDCCH at 1906,1908. This is followed by PDSCH transmissions at 1910,1912. For the PDSCH transmission 1910 to the TUE 1902, at 1914, if NDI is toggled for the first TB, then the TUE 1902 decodes the received data, and otherwise, the TUE 1902 decodes HARQ combined data for the first TB. For the PDSCH transmission 1912 to the CUE 1904, at 1916, if NDI is toggled for the second TB, then the CUE 1904 decodes the received data, and otherwise, the CUE 1904 decodes HARQ combined data for the second TB. At 1918, If the CUE 1904 is successful in decoding received data for the second TB, the CUE 1904 sends a successful decoded second TB to the TUE 1902. At 1920, the TUE 1902 sends a HARQ-ACK feedback (ACK or NACK) for the the first and second TB to the gNB 1900.

### Code Block Group (CBG) Based Re-Transmission for UC

In some embodiments, for handling large TB sizes, code block group (CBG) based HARQ is used to improve the efficiency and reduce the latency. With this approach, a TB is divided into a number of CBG(s). Each CBG consists of a number of CBs (code block).

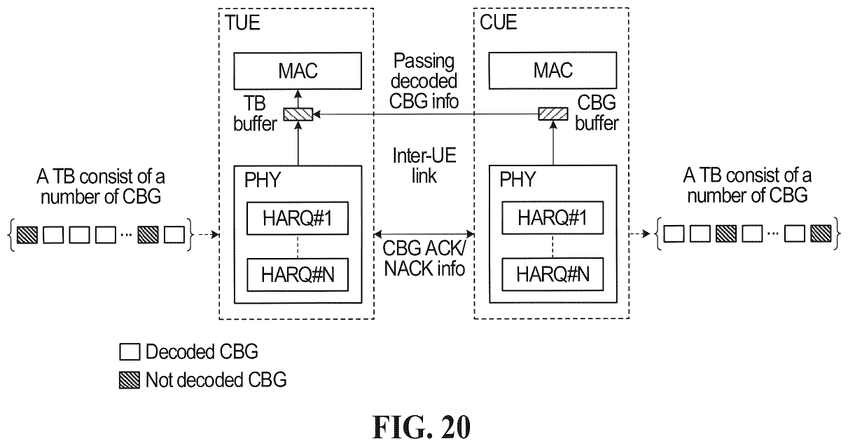

An example is illustrated in FIG. 20, which shows that a TB could be divided into a number of CBG(s). Each CBG could consist of a number of CBs (code blocks). The TUE or CUE could attempt to decode each CB. An ACK would be generated if all the CB(s) in a CBG are correctly decoded, otherwise, a NACK would be generated for a CBG.

For a CBG-based HARQ process, ACK/NACK are generated in the PHY layer and thus there is no need to exchange information with the MAC layer. This would reduce the latency as well. TUE and CUE conduct their own CBG based HARQ until all the CBG(s) in the TB are decoded successfully. The CUE then passes the ACK indication for the TB and the decoded TB to the TUE.

To accelerate the HARQ process when a TB is duplicated (the same TB is received at both TUE and CUE), some CBG based ACK/NACK information could be exchanged between the TUE and CUE. For example, the TUE (or CUE) could pass their ACK/NACK information for each CBG to the other UE, and thus, the other UE (TUE or CUE) may not need to require the re-transmission of that CBG. When all CBG(s) are received correctly at either of the TUE/CUE or combined, an ACK could be indicated for the whole TB, and the CUE could pass the correctly decoded CBG(s) by the CUE to the TUE for it to generate the whole TB (using decoded CBG(s) from both TUE and CUE).

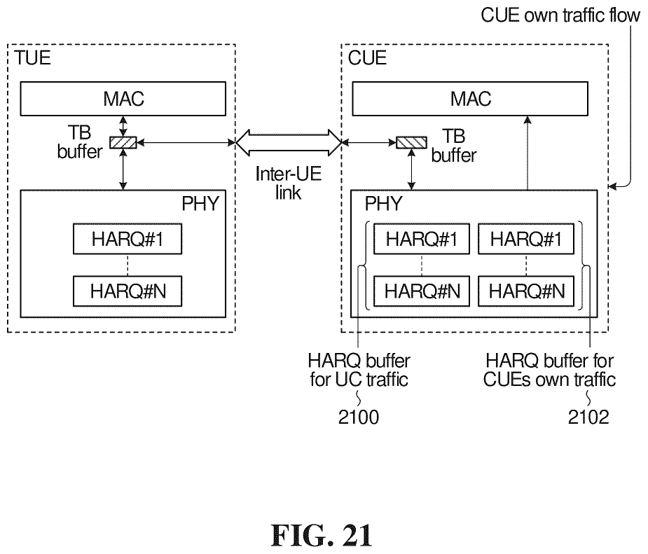

In some embodiments, as both the CUE's own transmission (non-UC transmission) and UC transmission may require HARQ soft buffer (kind of resources) to support HARQ operation, the HARQ soft buffer could be split to accommodate both UC traffic and CUE's own traffic, as shown in FIG. 21 which shows HARQ buffer 2102 for the CUE's own traffic and HARQ buffer 2100 for UC traffic. For example, if a total of M HARQ processes can be supported with corresponding HARQ buffer allocated, N1 HARQ processes can be configured for UC traffic and N2 HARQ processes can be configured for CUE's own traffic. Such configuration, for example, can be made using higher layer signal such as RRC or MAC CE.

The HARQ process for UC traffic and CUE's own traffic can be configured in different manners. In one example, for UC traffic, HARQ processes are numbered from 1 to N1 and for the CUE's own traffic, HARQ processes are numbered from 1 to N2, with N1+N2<=M.

In another example, for UC traffic, HARQ processes are numbered from 1 to N1 and for the CUE's own traffic, HARQ processes are numbered from N1+1 to N2<=M.

The HARQ soft buffer here could refer to either UL or DL HARQ buffers.

For uplink, the HARQ soft buffer could refer to circular buffer (or rate matching buffer after channel encoder) storing different RV version of a TB after channel encoding.

For downlink, the HARQ soft buffer could refer to a buffer used to store the received data (original transmission or re-transmission) before channel decoding.

For UC data traffic, one HARQ entity could be configured in common MAC for UC (which could be located in TUE or another UE).

In some implementations, for the TB duplicate case, the number of HARQ processes for CUE and TUE is configured the same (i.e., TUE and CUE are configured with the same number of HARQ processes) or one set of HARQ processes can be configured for both TUE and CUE.

For the TB split case, the number of HARQ processes for CUE and TUE can be configured differently (i.e., TUE and CUE can be configured with different numbers of HARQ processes). The number of HARQ processes configured for TUE or CUE could depend on the amount of UC traffic being transmitted. For example, if more UC traffic is transmitted from gNB to TUE, a larger number of HARQ processes can be configured for TUE.

The configuration of the number of HARQ processes can be sent to the UE and passed to the CUE, or they can be sent to both TUE/CUE respectively.

Straightforward UE behaviors and data/signal flows for receiving downlink TB-based UC data traffic including TUE and SUE have been provided and described. In addition, some other aspects are provided including the CBG based HARQ process to support UC data traffic as well as HARQ process configuration to support both UC and non-UC data traffic.

Various embodiments are disclosed by way of example herein.

These embodiments include, for example, a method in a first UE. Such a method may involve receiving a first PDCCH scheduling a downlink joint UE transmission from a transmitter for a first UE, receiving a first TB from the transmitter based on the first PDCCH, and receiving data from a second UE over an inter-UE connection. From the perspective of a transmitter such as a network device, for example, a method may involve transmitting the first PDCCH scheduling the joint UE transmission, transmitting the first TB of data based on scheduling information in the first PDCCH to the first UE, and transmitting the second TB of data to the second UE.

Apparatus embodiments disclosed herein include an apparatus with at least one processor coupled with a memory storing instructions. The instructions, when executed by the at least one processor, may cause a UE or a transmitter to execute a method. Such a method, in the context of causing a UE to execute the method, may involve receiving a first PDCCH scheduling a downlink joint UE transmission from a transmitter to the UE, receiving a first TB from the transmitter based on the first PDCCH, and receiving data from a second UE over an inter-UE connection. In the context of causing a transmitter to execute a method, such a method may involve transmitting the first PDCCH scheduling the joint UE transmission from the transmitter for the first UE, transmitting the first TB of data from the transmitter to the first UE based on the first PDCCH from the first UE, and transmitting the second TB of data from the transmitter to the second UE.

The receiving UE that receives the first PDCCH, receives the first TB, and receives the data from the second UE in these examples may be referred to herein as a first UE, a TUE, or a UE in a TUE role, and the second UE in these examples may be referred to herein as a CUE or a UE in a CUE role. The joint UE transmission in these examples may be referred to herein as a UC transmission. The transmitter in these examples may be a network device such as a gNB, or another UE. In the case of a UE as the transmitter, the UE may be referred to as a transmitting UE, a third UE, an SUE, or a UE in an SUE role.

These and other features herein should be interpreted accordingly. For example, any features disclosed herein in the context of a TUE or a UE in a TUE role apply more generally to a UE to which TB data is destined. Such a UE is the first UE or the receiving UE in the examples above. Features disclosed herein in the context of an SUE or a UE in an SUE role may apply more generally to a UE from which TB data that is to be transmitted is originated, or even more generally to a transmitter from which TB data that is to be transmitted is originated. In the above examples, a transmitting UE is referenced as a third UE, and in some embodiments the transmitter is a network device.

Similarly, features disclosed herein in the context of a CUE or a UE in a CUE role apply more generally to a UE to which a second TB of data that is originated from a transmitter is transmitted. Such a UE is the second UE in the examples above. Features that are disclosed herein in the context of network, network-side, or gNB features, for example, apply more generally to network devices.

Please note that the different embodiments may be implemented separately or combined. Although a combination of features is shown in the illustrated embodiments, not all of them need to be combined to realize the benefits of various embodiments of this disclosure. In other words, a method, apparatus, or system designed according to an embodiment of this disclosure will not necessarily include all of the features (including steps) shown in any one of the Figures or all of the portions schematically shown in the Figures. Moreover, selected features of one example embodiment may be combined with selected features of other example embodiments.

Numerous modifications and variations of the present disclosure are possible in light of the above teachings. It is therefore to be understood that within the scope of the appended claims, the disclosure may be practiced otherwise than as specifically described herein.

For instance, the present disclosure encompasses the following examples, and others.

According to an example 1, a method in a first user equipment (UE) involves receiving a first physical downlink control channel (PDCCH) scheduling a downlink UE cooperation (UC) transmission for the first UE in a target UE (TUE) role; receiving a first transport block (TB) based on the first PDCCH; receiving data from a second UE in a cooperative UE (CUE) role over an inter-UE connection.

An example 2 relates to the method of example 1 wherein: receiving the first TB based on the first PDCCH involves receiving the first TB from a network device.

An example 3 relates to the method of example 1 wherein: receiving the first TB based on the first PDCCH comprises receiving the first TB from a third UE.

An example 4 relates to the method of example 1 wherein: when the UC transmission is a TB duplicate UC transmission, the data is a duplicate of the first TB, or the data can be used to generate the first TB; when the UC transmission is a TB split UC transmission, the data is a second TB different than the first TB, or the data can be used to generate the second TB.

An example 5 relates to the method of example 4 wherein: the first PDCCH includes an indication of whether the UC transmission is to be the TB duplicate UC transmission or the TB split UC transmission.

An example 6 relates to the method of example 4 further comprising: receiving higher layer signaling to indicate whether the UC transmission is the TB duplicate UC transmission or the TB split UC transmission.

An example 7 relates to the method of example 4 wherein: the first PDCCH contains scheduling information for only the first TB to indicate that the TB duplicate UC transmission is being scheduled; or the first PDCCH contains scheduling information for the first TB and the second TB to indicate that the TB split UC transmission is being scheduled.

An example 8 relates to the method of example 4 wherein: the first PDCCH contains scheduling information for two TBs and in a case where the scheduling information for the two TBs is the same, the TB duplicate UC transmission is being scheduled, and in a case where the scheduling information for the two TBs is different, the TB split UC transmission is being scheduled.

An example 9 relates to the method of example 4 wherein the first PDCCH is scrambled with a first radio network temporary identifier (RNTI) to indicate the TB duplicate UC transmission and the first PDCCH is scrambled with a second RNTI to indicate the TB split UC transmission.

An example 10 relates to the method of any one of examples 1 to 8, further comprising: receiving a second PDCCH scheduling a transmission of a normal downlink transmission to the first UE; wherein the first PDCCH is scrambled with a first radio network temporary identifier (RNTI) to indicate that the first PDCCH is scheduling the downlink UC transmission and the second PDCCH is scrambled with a second RNTI to indicate that the second PDCCH is scheduling the normal downlink transmission to the first UE.

An example 11 relates to the method of any one of examples 4 to 9, wherein: for the TB duplicate UC transmission, the first PDCCH contains a new data indicator (NDI) indicating whether a new transmission is being scheduled or a retransmission is being scheduled.

An example 12 relates to the method of any one of examples 4 to 9, wherein: for the TB split UC transmission, the first PDCCH contains a first new data indicator (NDI) indicating whether a new transmission or a retransmission is being scheduled for transmission to the first UE, and contains a second new data indicator (NDI) indicating whether a new transmission or a retransmission is being scheduled for transmission to the second UE in the CUE role.

According to an example 13, an apparatus in a user equipment (UE) includes at least one processor coupled with a memory storing instructions, wherein when the instructions executed by the at least one processor, cause the UE to execute a method that involves: receiving a first physical downlink control channel (PDCCH) scheduling a downlink UE cooperation (UC) transmission for the UE in a target UE (TUE) role; receiving a first transport block (TB) based on the PDCCH; receiving data from a second UE in a cooperative UE (CUE) role over an inter-UE connection.

An example 14 relates to the apparatus of example 13 wherein: receiving the first transport block (TB) based on the first PDCCH comprises receiving the first TB from a network device.

An example 15 relates to the apparatus of example 13 wherein: receiving the first transport block (TB) based on the first PDCCH comprises receiving the first TB from a third UE.

An example 16 relates to the apparatus of example 13 wherein: when the UC transmission is a TB duplicate UC transmission, the data is a duplicate of the first TB, or data can be used to generate the first TB; when the UC transmission is a TB split UC transmission, the data is a second TB different than the first TB, or the data can be used to generate the second TB.

An example 17 relates to the apparatus of example 16 wherein: the first PDCCH includes an indication of whether the UC transmission is to be the TB duplicate UC transmission or the TB split UC transmission.

An example 18 relates to the apparatus of example 16, the method further comprising: receiving higher layer signaling to indicate whether the UC transmission is the TB duplicate UC transmission or the TB split UC transmission.

An example 19 relates to the apparatus of example 16 wherein: the first PDCCH contains scheduling information for only the first TB to indicate the TB duplicate UC transmission is being scheduled; the first PDCCH contains scheduling information for the first TB and the second TB to indicate the TB split UC transmission is being scheduled.

An example 20 relates to the apparatus of example 16 wherein: the first PDCCH contains scheduling information for two TBs and in a case where the scheduling information for the two TBs is the same, the TB duplicate UC transmission is being scheduled, and in a case where the scheduling information for the two TBs is different, the TB split UC transmission is being scheduled.

An example 21 relates to the apparatus of example 16 wherein the first PDCCH is scrambled with a first radio network temporary identifier (RNTI) to indicate the TB duplicate UC transmission and the first PDCCH is scrambled with a second RNTI to indicate the TB split UC transmission.

An example 22 relates to the apparatus of any one of examples 13 to 20, the method further comprising: receiving a second PDCCH scheduling a transmission of normal downlink transmission to the first UE; wherein the first PDCCH is scrambled with a first radio network temporary identifier (RNTI) to indicate that the first PDCCH is scheduling the downlink UC transmission and the second PDCCH is scrambled with a second RNTI to indicate that the second PDCCH is scheduling the normal downlink transmission to the first UE.

An example 23 relates to the apparatus of any one of examples 16 to 21, wherein: for the TB duplicate UC transmission, the first PDCCH contains a new data indicator (NDI) indicating whether a new transmission is being scheduled or a retransmission is being scheduled.

An example 24 relates to the apparatus of any one of examples 16 to 21, wherein: for the TB split UC transmission, the first PDCCH contains a first new data indicator (NDI) indicating whether a new transmission or a retransmission is being scheduled for transmission to the first UE, and contains a second new data indicator (NDI) indicating whether a new transmission or a retransmission is being scheduled for transmission to the second UE in the CUE role.

According to an example 25, a method in a network device involves: transmitting a first physical downlink control channel (PDCCH) scheduling a downlink UE cooperation (UC) transmission for a first UE in a target UE (TUE) role; transmitting a first TB based on scheduling information in the PDCCH to the first UE; transmitting a second TB to a second UE in a cooperative UE (CUE) role.

An example 26 relates to the method of example 25 wherein: when the UC transmission is a TB duplicate UC transmission, the second TB is a duplicate of the first TB; when the UC transmission is a TB split UC transmission, the second TB is different than the first TB.

An example 27 relates to the method of example 26 wherein: the first PDCCH includes an indication of whether the UC transmission is to be the TB duplicate UC transmission or the TB split UC transmission.

An example 28 relates to the method of example 26 further comprising: transmitting higher layer signaling to indicate whether the UC transmission is the TB duplicate UC transmission or the TB split UC transmission.

An example 29 relates to the method of example 26 wherein: the first PDCCH contains scheduling information for only the first TB to indicate that the TB duplicate UC transmission is being scheduled; the first PDCCH contains scheduling information for the first TB and the second TB to indicate that the TB split UC transmission is being scheduled.

An example 30 relates to the method of example 26 wherein: the first PDCCH contains scheduling information for two TBs and in a case where the scheduling information for the two TBs is the same, the TB duplicate UC transmission is being scheduled, and in a case where the scheduling information for the two TBs is different, the split TB UC transmission is being scheduled.

An example 31 relates to the method of example 26 wherein the first PDCCH is scrambled with a first radio network temporary identifier (RNTI) to indicate the TB duplicate UC transmission and the first PDCCH is scrambled with a second RNTI to indicate the TB split UC transmission.

An example 32 relates to the method of any one of examples 26 to 31, further comprising: transmitting a second PDCCH scheduling a transmission of normal downlink UE transmission; wherein the first PDCCH is scrambled with a first radio network temporary identifier (RNTI) to indicate that the first PDCCH is scheduling the downlink UC transmission to the first UE and the second PDCCH is scrambled with a second RNTI to indicate that the second PDCCH is scheduling the normal downlink UE transmission to the first UE.

An example 33 relates to the method of any one of examples 26 to 31, wherein: for the TB duplicate UC transmission, the first PDCCH contains a new data indicator (NDI) indicating whether a new transmission is being scheduled or a retransmission is being scheduled.

An example 34 relates to the method of any one of examples 26 to 31, wherein: for the TB split UC transmission, the first PDCCH contains a first new data indicator (NDI) indicating whether a new transmission or a retransmission is being scheduled for transmission to the first UE, and contains a second new data indicator (NDI) indicating whether a new transmission or a retransmission is being scheduled for transmission to the second UE in the CUE role.

According to an example 35, an apparatus in a network device includes at least one processor coupled with a memory storing instructions, wherein when the instructions executed by the at least one processor, cause the network device to execute a method comprising: transmitting a first physical downlink control channel (PDCCH) scheduling a downlink UE cooperation (UC) transmission for a first UE in a target UE (TUE) role; transmitting a first transport block (TB) based on the first PDCCH to the first UE; transmitting a second TB to a second UE in a cooperative UE (CUE) role.

An example 36 relates to the apparatus of example 35 wherein: when the UC transmission is a transport block (TB) duplicate UC transmission, the second TB is a duplicate of the first TB; when the UC transmission is a transport block (TB) split UC transmission, the second TB is different than the first TB.

An example 37 relates to the apparatus of example 36 wherein: the first PDCCH includes an indication of whether the UC transmission is to be the TB duplicate UC transmission or the TB split UC transmission.

An example 38 relates to the apparatus of example 36 further comprising: transmitting higher layer signaling to indicate whether the UC transmission is the TB duplicate UC transmission or a TB split UC transmission.

An example 39 relates to the apparatus of example 36 wherein: the first PDCCH contains scheduling information for only the first TB to indicate that TB duplicate UC transmission is being scheduled; the first PDCCH contains scheduling information for the first TB and the second TB to indicate that TB split UC transmission is being scheduled.

An example 40 relates to the apparatus of example 36 wherein: the first PDCCH contains scheduling information for two TBs and in a case where the scheduling information for the two TBs is the same, the TB duplicate UC transmission is being scheduled, and in a case where the scheduling information for the two TBs is different, the split TB UC transmission is being scheduled.

An example 41 relates to the apparatus of example 36 wherein the first PDCCH is scrambled with a first radio network temporary identifier (RNTI) to indicate the TB duplicate UC transmission and the first PDCCH is scrambled with a second RNTI to indicate the TB split UC transmission.

An example 42 relates to the apparatus of any one of examples 35 to 41 further comprising: transmitting a second PDCCH scheduling a transmission of normal downlink UE transmission; wherein the first PDCCH is scrambled with a first radio network temporary identifier (RNTI) to indicate that the first PDCCH is scheduling the downlink UC transmission to the first UE and the second PDCCH is scrambled with a second RNTI to indicate that the second PDCCH is scheduling the normal downlink UE transmission to the first UE.

An example 43 relates to the apparatus of any one of examples 36 to 41 wherein: for the TB duplicate UC transmission, the first PDCCH contains a new data indicator (NDI) indicating whether a new transmission is being scheduled or a retransmission is being scheduled.

An example 44 relates to the apparatus of any one of examples 36 to 41 wherein: for the TB split UC transmission, the first PDCCH contains a first new data indicator (NDI) indicating whether a new transmission or a retransmission is being scheduled for transmission to the first UE, and contains a second new data indicator (NDI) indicating whether a new transmission or a retransmission is being scheduled for transmission to the second UE in the CUE role.

1. A method comprising:
receiving a first physical downlink control channel (PDCCH) scheduling a downlink joint user equipment (UE) transmission from a transmitter for a first UE;
receiving a first transport block (TB) from the transmitter based on the first PDCCH; and
receiving data from a second UE over an inter-UE connection.

2. The method of claim 1, wherein:
the transmitter is a network device, and the receiving the first TB based on the first PDCCH comprises:
receiving the first TB from the network device.

3. The method of claim 1, wherein:
the transmitter is a third UE, and the receiving the first TB based on the first PDCCH comprises:
receiving the first TB from the third UE.

4. The method of claim 1, wherein:
when the downlink joint UE transmission is a TB duplicate joint UE transmission, the data is a duplicate of the first TB, or the first TB is generated based on the data; or
when the downlink joint UE transmission is a TB split joint UE transmission, the data is a second TB different than the first TB, or the second TB is generated based on the data.

5. The method of claim 4, wherein:
the first PDCCH includes an indication of whether the downlink joint UE transmission is to be the TB duplicate joint UE transmission or the TB split joint UE transmission.

6. The method of claim 4, wherein:
the first PDCCH contains scheduling information for only the first TB to indicate that the TB duplicate joint UE transmission is scheduled; or
the first PDCCH contains scheduling information for the first TB and the second TB to indicate that the TB split joint UE transmission is scheduled.

7. The method of claim 4, wherein:
the first PDCCH contains scheduling information for two TBs; and
based on that the scheduling information for the two TBs is the same, the TB duplicate joint UE transmission is scheduled, or based on that the scheduling information for the two TBs is different, the TB split joint UE transmission is scheduled.

8. The method of claim 4, wherein the first PDCCH is scrambled with a first radio network temporary identifier (RNTI) to indicate the TB duplicate joint UE transmission, or the first PDCCH is scrambled with a second RNTI to indicate the TB split joint UE transmission.

9. The method of claim 4, wherein:
for the TB duplicate joint UE transmission, the first PDCCH contains a new data indicator (NDI) indicating whether a new transmission is scheduled or a retransmission is scheduled.

10. The method of claim 4, wherein:
for the TB split joint UE transmission, the first PDCCH contains a first NDI indicating whether a new transmission or a retransmission is scheduled for transmission to the first UE, and contains a NDI indicating whether a new transmission or a retransmission is scheduled for transmission to the second UE.

11. An apparatus comprising at least one processor coupled with a memory storing instructions, wherein the instructions, when executed by the at least one processor, cause a user equipment (UE) to execute operations comprising:
receiving a first physical downlink control channel (PDCCH) scheduling a downlink joint UE transmission from a transmitter for the UE, wherein the apparatus is or is part of the UE;
receiving a first transport block (TB) from the transmitter based on the first PDCCH; and
receiving data from a second UE over an inter-UE connection.

12. The apparatus of claim 11, wherein:
the transmitter is a network device, and the receiving the first TB based on the first PDCCH comprises:
receiving the first TB from the network device.

13. A method comprising:
transmitting a first physical downlink control channel (PDCCH) scheduling a downlink joint user equipment (UE) transmission from a transmitter for a first UE;
transmitting a first transport block (TB) of data from the transmitter to the first UE based on scheduling information in the first PDCCH; and
transmitting a second TB of data from the transmitter to a second UE.

14. The method of claim 13, wherein:
when the downlink joint UE transmission is a TB duplicate joint UE transmission, the second TB is a duplicate of the first TB; or
when the downlink joint UE transmission is a TB split joint UE transmission, the second TB is different than the first TB.

15. The method of claim 14, wherein:
the first PDCCH includes an indication of whether the downlink joint UE transmission is to be the TB duplicate joint UE transmission or the TB split joint UE transmission.

16. The method of claim 14, wherein:
the first PDCCH contains scheduling information for only the first TB to indicate that the TB duplicate joint UE transmission is scheduled; or
the first PDCCH contains scheduling information for the first TB and the second TB to indicate that the TB split joint UE transmission is scheduled.

17. The method of claim 14, wherein:
the first PDCCH contains scheduling information for two TBs; and
based on that the scheduling information for the two TBs is the same, the TB duplicate joint UE transmission is scheduled, or based on that the scheduling information for the two TBs is different, the split TB joint UE transmission is scheduled.

18. The method of claim 14, wherein the first PDCCH is scrambled with a first radio network temporary identifier (RNTI) to indicate the TB duplicate joint UE transmission, or the first PDCCH is scrambled with a second RNTI to indicate the TB split joint UE transmission.

19. The method of claim 14, wherein:
for the TB duplicate joint UE transmission, the first PDCCH contains a new data indicator (NDI) indicating whether a new transmission is scheduled or a retransmission is scheduled.

20. The method of claim 14, wherein:
for the TB split joint UE transmission, the first PDCCH contains a first new data NDI indicating whether a new transmission or a retransmission is scheduled for transmission to the first UE, and contains a second NDI indicating whether a new transmission or a retransmission is scheduled for transmission to the second UE.
